(19) United States
(12) Patent Application Publication
(10) Pub. No.: US 2009/0000522 A1
(43) Pub. Date: Jan. 1, 2009

(54) FRAME ASSEMBLY FOR A FOLDING WORKBENCH

(75) Inventors: Matthew Spencer Collins, Meppershall (GB); Matthew Robert Blaylock, Tunbridge Wells (GB)

Correspondence Address: BAINWOOD HUANG & ASSOCIATES LLC, 2 CONNECTOR ROAD, WESTBOROUGH, MA, 01581, US

(73) Assignee: FREEFORM DESIGN & INNOVATION LIMITED, Shefford (GB)

(21) Appl. No.: 12/133,196

(22) Filed: Jun. 4, 2008

Related U.S. Application Data
(63) Continuation of application No. PCT/EP2006/069398, filed on Dec. 6, 2006.

(30) Foreign Application Priority Data
Dec. 8, 2005 (GB) 0525053.5
Mar. 2, 2006 (GB) 0604173.5

(51) Int. Cl. B25H 1/04; B25H 1/14

(52) U.S. Cl. 108/12; 108/115; 108/170; 108/50.02; 108/161

(57) ABSTRACT

There is provided a frame assembly for a foldable workbench comprising a frame assembly for a workbench that is reversibly foldable from an in-use to a folded configuration comprising a central spine; first and second primary work surface frames, each work surface frame having an inner edge, an outer edge and two side edges, wherein each said inner edge thereof hingedly mounts to the central spine such that the primary work surface frames are foldable towards each other; and first and second opposing pairs of legs, each leg pivotally mounting to one end of an outer edge of the first and second primary work surface frames, such that the legs of each opposing pair are foldable towards each other. The inner edge of each of the first and second primary work surface frames hingedly mounts to the central spine by a distinct hinge mounting such that in the folded configuration, opposing side edges of the respective first and second primary work surface frames are brought parallel with each other and each of the legs is brought parallel with a side edge thereof.

### CROSS REFERENCE TO RELATED APPLICATIONS

This patent application claims priority to International Application Number PCT/EP2006/069398 filed on Dec. 6, 2006 which claims priority to GB Patent Application No. 0525053.6 filed on Dec. 8, 2005, and to GB Patent Application No. 0604173.5 filed on Mar. 2, 2006, the contents and teachings of which are hereby incorporated by reference in their entirety.

### FIELD

The present invention relates to a folding workbench and frame assembly therefor, which is readily and reversibly foldable from an ‘in-use’ configuration to a compact ‘folded’ configuration.

### BACKGROUND

When performing woodworking, metalworking or other ‘do it yourself’ tasks it is common to make use of a workbench that provides a relatively large, but also sturdy work surface. Since such workbenches are typically not required for daily use it is desirable for them to be stowable in disassembled or folded-up form. It is also desirable that the stowed form is as compact as possible and that the time and effort required to translate the workbench from its stowed to in-use position be minimized.

### SUMMARY

The Applicant has now devised a folding workbench that is stowable in highly compact form yet readily and safely unfolds with the minimum of time and effort to provide a relatively large and sturdy work surface. This workbench further allows for the accommodation of useful additional features such as a storage tray, housing for electrical equipment and integral vice feature(s).

The Applicant's workbench employs a central spine to which first and second primary work surface frames hingedly mount such that the primary work surface frames hingedly mounts to the central spine by a distinct hinge mounting with each hinge mounting typically spaced horizontally from the other. In the folded configuration, the outer edges of the respective first and second primary work surface frames rest parallel with each other and each of the legs of the workbench rests parallel with a side edge thereof.

An additional feature of the Applicant's workbench is that it may be used in an asymmetrical mode of operation in which half of the workbench is mounted to a wall and the other half extends from the wall. Thus, additional flexibility of use is provided, which makes the workbench particularly amenable to usage in conditions of restricted space.

It is an object of the present invention to provide a workbench that provides a relatively large work surface but that is also conveniently and safely stowable in highly compact form.

According to one aspect of the present invention there is provided a frame assembly for a workbench that is reversibly foldable from an in-use to a folded configuration comprising:

a central spine;

first and second primary work surface frames, each work surface frame having an inner edge, an outer edge and two side edges, wherein each said inner edge thereof hingedly mounts to the central spine such that the primary work surface frames are foldable towards each other; and

first and second opposing pairs of legs, each leg pivotally mounting to one end of an outer edge of the first and second primary work surface frames, such that the legs of each opposing pair are foldable towards each other,

wherein the inner edge of each of the first and second primary work surface frames hingedly mounts to the central spine by a distinct hinge mounting such that in the folded configuration, opposing side edges of the respective first and second primary work surface frames are brought parallel with each other and each of the legs is brought parallel with a side edge thereof.

The present invention relates to a frame assembly for a workbench that is readily and reversibly foldable from an in-use to a folded configuration. The frame assembly is desirably supplemented with one or more bench and/or utility features such as to provide the full workbench.

The frame assembly comprises a central spine. The central spine is suitably rigid and locates about the central folding axis of the frame assembly. In embodiments, the central spine has an elongate rectangular (e.g. box form), elongate open rectangular (e.g. open box form) or elongate cylindrical (e.g. tubular) form. For compactness of folding, the distinct hinge mountings preferably locate inboard of the central spine (e.g. within the space defined by planes defined by the lateral extent of the central spine). Suitably, the central spine defines a rectangular top surface (e.g. a plate), which in the in-use configuration preferably defines a central part of the work surface of the workbench.

The frame assembly further comprises first and second primary work surface frames suitable for receipt and/or definition of first and second primary work surfaces. In one aspect, the first and second primary work surfaces are separately provided to their primary work surface frames, to which they are secured by suitable securing means (e.g. screw mounting, bracket fixing or slide/track mounting). In another aspect, the first and second primary work surface frames actually define the first and second primary work surfaces (i.e. integral frame structure).

Each work surface frame suitably has an inner edge, an outer edge and two side edges. Typically, the dimensions of the first and second work surfaces frames and edges thereof are selected to match each other. Each inner edge of the first and second work surface frames hingedly mounts to the central spine such that the primary work surface frames are foldable towards each other (i.e. as in the folded configuration).

The frame assembly is provided with at least two (i.e. first and second) opposing pairs of legs. Each leg pivotally mounts to one end (typically, the outer end) of an outer edge of the first and second primary work surface frames such that the legs of each opposing pair are foldable towards each other. In the in-use configuration, the legs extend generally downwards to typically provide a four leg supporting structure for the first and second primary work frames.

For additional stability, adjacent pairs of legs (i.e. those pairs of legs which mount to an identical outer edge of either the first or second primary work surface frames) are provided with a cross-brace. Preferably, both pairs of adjacent legs (of the four leg supporting structure) are cross-braced. Suitably, the ends of the legs are provided with feet. Feet comprised of rubber or of a similar flexible or rubber-like material are preferable.

The inner edge of each of the first and second primary work surface frames hingedly mounts to the central spine by a distinct hinge mounting such that in the folded configuration, the side edges of the respective first and second primary work surface frames (i.e. opposing side edges) are brought parallel with each other and each of the legs is brought parallel with a side edge thereof. Preferably, in the folded configuration the (top surfaces of the) primary and second work surfaces rest flush with each other and the legs rest flush with the underside thereof.

Each primary work surface frames mounts to the central spine by a distinct (i.e. separate) hinge mounting. The distinct first and second hinge mountings are suitably arranged (e.g. in parallel fashion to each other) about the central spine such as to define first and second hinge axes that are parallel to and spaced apart slightly from each other. The relative spacing of the axes of the hinge mountings is selected to allow for compact folding of the frame assembly and in particular, for flush accommodation of the first and second primary work surfaces in the folded configuration. Typical hinge axis spacing may be from 5 to 500 mm, preferably from 10 to 100 mm (e.g. 30-40 mm) apart. In embodiments, the first and second hinge axes lie below the central spine, for example below the rectangular top surface of the central spine.

In one example, for a hinge spacing of say 40 mm, the first hinge locates on a first axis that is laterally spaced 20 mm from but parallel to the central axis defined by the central spine and the second hinge locates on a second axis that is laterally spaced 40 mm from the first axis, but also 20 mm laterally from and parallel to the central axis defined by the central spine (i.e. one on either side of the central spine). Alternatives and equivalents to hinge mountings are envisaged herein including arrangements (e.g. series arrangements) of pivot mountings and other mechanical arrangements capable of providing hinge-like functionality. The spaced hinge mountings may either comprise separate hinges or alternatively, the hinges may be coupled in some way (e.g. by a coupling arm or geared link) including for example, by a compass type hinge.

Where the central spine defines a rectangular top surface (e.g. a plate) having major and minor rectangle edges, the hinge mountings preferably locate inboard of (i.e. within the leading edges, which is to say major edges, of) that rectangular top surface.

Suitably, the frame assembly additionally comprising first and/or second subsidiary work surface frames, each respective subsidiary work surface frame pivotally mounting to an outer edge of the first and second primary work surface frames. Suitably, in the folded configuration, each respective subsidiary work surface frame is brought parallel with its primary work surface frame. Suitably, in the folded configuration, each respective subsidiary work surface frame is brought parallel with the legs.

The first and/or second subsidiary work surface frames are suitable for receipt and or definition of first and second subsidiary work surfaces. In one aspect, the first and second subsidiary surfaces are separately provided to their subsidiary work surface frames, to which they are secured by suitable securing means (e.g. screw mounting, bracket fixing or slide/track mounting). In another aspect, the first and second subsidiary work surface frames actually define the first and second subsidiary work surfaces (i.e. integral frame structure).

A preferred configuration includes both first and second subsidiary work surface frames; although a less preferred configuration including only one subsidiary work surface frame is envisaged.

Suitably, a trunk extends downwards from the central spine to define a trunk cavity. That is to say, the central spine is provided with a trunk having trunk walls that extends downwards (i.e. towards the floor) from the central spine, and generally a trunk base. The trunk typically reaches only part-ways to the floor when the workbench is in the ‘in use’ position. The trunk may extend downwards across the full length of the central spine or only from a part length thereof. In embodiments, the trunk has a box form or an open box form. In embodiments, the trunk is integrally formed with the central spine. Use of a trunk extending to only a part length of the central spine is preferable to allow for accommodation of the user's legs when seated at the workbench.

Suitably, the distinct hinge mountings locate inboard of the trunk (i.e. within the space defined by planes defined by the downwardly extending walls of the trunk). In embodiments, the first and second hinge axes of the distinct hinge mountings lie within the upper part (i.e. that part closest to the central spine and furthest from the trunk base) of the trunk.

Suitably, in the folded configuration the trunk locates directly underneath the first and second primary work surfaces and frames. This assists with compact stowage of the trunk.

Suitably, the width of the trunk approximates to the combined thickness of the first and second primary work surface frames, and their respective first and second work surfaces, when brought together in the folded configuration. Again, this assists with compact stowage of the trunk. Suitably, the length of downward extent of the trunk added to the length of one of the side edges of the first and second primary work surface frames equates to less than or approximately equal to the length of one of the legs.

Most preferably, in the folded configuration the trunk locates directly underneath the first and second primary work surface frames and the combined length of these elements is roughly equal to (i.e. only slightly more than or less than) that of the legs. Thus, in essence, the length of the legs defines the maximum extent of the compact folded configuration and the width thereof is only slightly greater than the combined width of the opposing legs and thicknesses of the work surfaces (as lie side-by-side each other).

Suitably, the frame assembly is provided with struts that pivotally connect the lower part (i.e. closest to the floor) of the trunk to each of the respective legs such that in the in-use configuration the struts define a tray framework for receipt of a tray. That is to say, in the in-use configuration the struts preferably define a flat/level framework suitable for optional receipt of a tray or other flat surface.

Suitably, leg cross-struts are also provided to adjacent legs, each leg cross-strut running parallel to the outer edge of one of the first and second primary work surface frames. Suitably, the leg cross-struts further define the framework for receipt of a tray.

The trunk is suitably shaped to define an inner trunk cavity for storage of tools and/or receipt of utility equipment (e.g. electrical plug socketry or cable storage).

Suitably, the frame assembly additionally comprises first and second couplings that act to respectively couple said trunk to the underside of each of the first and second subsidiary work surface frames. Preferably, each of said first and second couplings acts such as to move (e.g. push and/or pull) the respective underside of each of the first and second subsidiary work surface frames parallel with the respective underside of each of the first and second primary work surface frames on folding of the frame assembly from the in-use to the folded configuration. Preferably, also each of said first and second couplings acts such as to push each of the first and second subsidiary work surface frames to their in-use position on unfolding of the frame assembly from the folded to in-use configuration. Most preferably, the couplings provide both push and pull function. Suitably, each of said couplings comprises a coupling arm, preferably a rigid strut. Suitably, each of said couplings shares a common pivot with the trunk mounted pivot of the trunk to leg strut.

In embodiments, each of said couplings is provided with a safety catch, which acts to prevent uncontrolled (or e.g. accidental) folding of the frame assembly of the workbench.

Suitably, for each coupling the safety catch comprises a latch arm, which pivotally mounts to the underside of the relevant subsidiary work surface frame (or in alternatives, to the underside of the relevant subsidiary work surface itself); said latch arm provided with at least a first latch element (e.g. a cutaway portion or slot) for latching interaction with a first latch pin provided to the coupling when the workbench is in the in-use configuration. In embodiments, that latching interaction is also enabled when the workbench is in a part-folded configuration, and the latching interaction must be broken to enable full folding of the workbench.

In embodiments, the latch arm is additionally provided with a second latch element (e.g. a cutaway portion or slot) for latching interaction with a second latch pin provided to the underside of the relevant primary work surface frame when the workbench is in the folded configuration.

In embodiments, a pair of such latch arms is provided, each of which pivotally mounts to the underside of the relevant subsidiary work surface frame (or in alternatives, to the underside of the relevant subsidiary work surface itself). Preferably, the pair of latch arms pivotally mounts about a common pivot mounting axis.

In embodiments, the or each latch arm is provided with an actuator arm (e.g. in the form of a horizontally extending rod), which actuator arm is arranged for ease of latching/delatching by the user. Where a pair of latch arms, each with an actuator arm is present, the pair of actuator arms preferably shares the same axis when the pair of latch arms is in the latched and/or fully unlatched positions. The actuator arms are movable independently.

Suitably, the frame assembly additionally includes one or more supports, which are provided to support either the first or second subsidiary work surface frames. Suitably, the one or more supports extend in supporting fashion to the first and/or second subsidiary work surface frames from one or more of the legs or from any leg cross-struts provided thereto. Preferably, each of the one or more supports comprises a snap-link (e.g. rod with snap-linkage or sliding latch) provided with a lock for locking said link in a rigid position.

Suitably, one support pivotally connects to each of the legs (i.e. for a four-legged frame assembly there are also four supports, preferably one extending to each corner of the unfolded workbench).

Suitably, that support-to-leg pivotal connection is shared (i.e. in common with) the strut-to leg pivotal connection that connects the aforementioned struts to their respective legs. As described above, the struts extend to a lower part (i.e. closest to the floor) of the trunk to define a tray framework.

Suitably, the frame assembly additionally comprises first and second sprung couplings, which act to respectively couple said trunk to the underside of each of the first and second primary work surface frames. The sprung couplings act such as to provide a degree of resistance to folding (and hence control and safety) when the workbench is folded up and provide a degree of spring assist when the workbench is unfolded.

Suitably, the frame assembly is symmetrical about the central spine. For strength and compactness symmetry is generally preferable in the overall frame assembly structure and in the arrangement of the component parts (e.g. work surfaces, couplings, struts and supports). Suitably however, the frame assembly also provides for an asymmetric mode of operation, in which one half of the workbench is folded and wall-mounted and the other half extended.

According to another aspect of the present invention there is provided a workbench comprising a frame assembly as described hereinabove; and first and second primary work surfaces provided to the first and second primary work surface frames.

Suitably, the workbench additionally comprises first and/or second subsidiary work surfaces provided to the first and/or second subsidiary work surface frames. In one particular aspect, at least one of the first and/or second subsidiary work surfaces mounts to its subsidiary work surface frame by a slide track mounting such that the subsidiary work surface is movable (laterally and along the slide track) relative to its subsidiary work surface frame (e.g. to form a clamping vice).

Suitably, the central spine defines a rectangular top surface (e.g. a plate), that in the in-use configuration preferably rests essentially co-planar with (or slightly below) the first and second primary work surfaces to define a central work surface of the workbench.

Preferably, the width of the minor edge of the rectangular top surface of the central spine corresponds essentially to the combined width of the first and second primary work surface frames and their respective first and second work surfaces, when brought together in the folded configuration. In other words, the width of the minor edge of the rectangular top surface of the central spine defines the flush, folded width of the first and second primary work surface frames and their respective first and second work surfaces.

On folding, the first and second primary work surface frames are suitably brought towards each other, passing over the central spine (e.g. top surface thereof) and meeting essentially flush alongside the central axis defined by the central spine, thereby providing maximum compactness of the folded configuration.

Preferably, in the folded configuration the (top surfaces of the) first and second primary work surfaces rest essentially flush with each other, and preferably the legs rest flush with the underside (i.e. bottom surfaces) of the first and second primary work surfaces. Preferably, in the folded configuration, the legs rest flush with the underside of the first and second primary work surfaces. In embodiments, the first and second subsidiary work surfaces are provided with an access hole to enable the user to access (and thereby, actuate) the actuator arm(s) of any latch arm(s) provided to the underside thereof.

In embodiments, the workbench is provided with a clamp for use in securing a workpiece, which is typically arranged for use with one or more dogs. In embodiments, the clamp and dogs are provided to any of the first and/or second primary work surfaces and/or the first and/or second subsidiary work surfaces. The clamp described herein may be used in conjunction with any suitable workbench, and thus comprises another aspect of the present invention.

In embodiments, the clamp comprises a base defining an upper plug sized and shaped for receipt within an access hole of a subsidiary work surface of the workbench. In embodiments, the base is provided with a flange, which in-use seats against the subsidiary work surface (in embodiments, the underside or topside thereof) when the plug portion seats within the access hole. In other embodiments, no flange is present. In embodiments, the plug includes a lateral slot arranged for receipt of a securing bolt, which is used to secure a sequential arrangement of a lower jaw; compressible (e.g. rubber) block; and upper jaw to the base. Suitably, a securing nut associates with the securing bolt to allow reversibly securable receipt of the arrangement of lower jaw; compressible (e.g. rubber) block; and upper jaw within the slot. One or more stops may be provided (e.g. to the upper jaw) to prevent the handle from turning more than a set amount (e.g. 1800) and thereby being overtightened or inadvertently undone.

In embodiments, a handle is received by the head of the securing bolt. Suitably, a handle-retaining bolt is used to secure the handle to the head of the securing bolt. In use, the handle is turned in a first rotational sense to cause a loosening of the securing bolt, which enables the jaw and block arrangement to be moved laterally within the slot. Suitably, the handle requires only to be turned in a reverse rotational sense through 90° (i.e. a quarter turn) relative to the base to allow for securing of the jaw and block arrangement at a particular lateral position within the slot of the base. As a result of such securing, the compressible (e.g. rubber) block is compressed and expands outwardly to exert a clamping force to secure a workpiece.

Suitably, the workbench additionally comprises an optional tray provided to the tray framework.

The frame assembly and workbench herein may be supplied fully assembled or in any suitable kit of parts form. There is also provided the use of the workbench herein in its folded and/or in-use configuration.

In one particular use configuration, one half of the work bench mounts to an external vertical surface (e.g. a wall) in folded configuration and the other half of the work bench is unfolded to its in-use configuration. Thus, the workbench may also be supplied as a kit of parts with an optional wall mounting.

The frame assembly and workbench herein has been described in relation to embodiments comprising both first and second primary work surface frames. A less preferred configuration comprising only ‘one half’ of the present workbench, and thus comprising only one primary and subsidiary work surface frame (and typically, one pair of legs associated therewith) is however, also envisaged. It will be appreciated that in one embodiment such ‘one half’ configuration would be suitable exclusively for use in the wall-mounted configuration. In another embodiment supporting legs (e.g. permanent, bolted on or flipped down) are provided to the underside of the trunk of the ‘one half’ configuration such that in use, the ‘one half’ workbench would be supported by these trunk-mounted legs (i.e. instead of the wall-mounting) and the pair of legs associated with the one primary and subsidiary work surface frame.

### BRIEF DESCRIPTION OF THE DRAWINGS

Embodiments of the present invention will now be described with reference to the accompanying drawings in which:

FIGS. 1a to 1d show perspective views of a first folding workbench herein in various stages as the workbench is folded up from the normal ‘in-use’ configuration (FIG. 1a) to the ‘folded’ configuration (FIG. 1d);

FIGS. 2a to 2e show side views of the first folding workbench herein in various stages as the workbench is folded up from the normal ‘in-use’ configuration (FIG. 2a) to the ‘folded’ configuration (FIG. 2e);

FIGS. 3a to 3d show perspective views of the first folding workbench herein in various stages as the workbench is folded up from the wall-mounted ‘in-use’ configuration (FIG. 3a) to the wall-mounted ‘folded’ configuration (FIG. 3d);

FIG. 4 shows a side view of the first folding workbench herein in the wall-mounted ‘in-use’ configuration;

FIG. 5 shows a perspective view of a second folding workbench herein in the ‘in-use’ configuration;

FIG. 6 shows a perspective view of a third folding workbench herein in the normal ‘in-use’ configuration;

FIG. 7a shows a perspective view of a detail of the central spine part of the first folding workbench of FIGS. 1a to 2e with the first primary work surface shown ghosted for ease of view;

FIG. 7b shows a perspective view of the first folding workbench of FIGS. 1a to 2e, with an exploded view of an inner cavity for receipt of electrical socketry.

FIGS. 8a and 8b show schematic end views of the arrangement of pivots of one half of the first folding workbench respectively in the in-use and folded configurations (and shown absent its legs in FIG. 8b for clarity of view);

FIG. 9 shows a side view of one-half of a fourth folding workbench herein with a safety catch feature as shown in the normal ‘in-use’ configuration;

FIG. 10 shows a perspective view of the safety catch feature of the fourth folding workbench of FIG. 9;

FIGS. 11a to 11c show side views of details of the fourth folding workbench with safety catch feature of FIG. 9, as respectively shown in the normal ‘in-use’, part-folded and folded configurations;

FIGS. 12a to 12c show perspective views (with part of the first primary work surface shown in cut-away view) of details of the fourth folding workbench with safety catch feature of FIG. 9, as respectively shown in the normal ‘in-use’, part-folded and folded configurations;

FIG. 13 shows a perspective view of a clamp for use with a workbench herein shown in a storage position;

FIGS. 14a and 14b respectively show perspective views of the top and underside of the clamp of FIG. 13 as shown in the clamp closed position;

FIG. 15 shows an exploded view of the clamp of FIG. 13;

FIG. 16 shows a sectional side view of the clamp of FIG. 13;

FIGS. 17a to 17d show perspective views from the top of sequential steps in securing a plank of wood to a fifth workbench herein, which incorporates the clamp of FIG. 13;

FIGS. 18a and 18b respectively show perspective views from the top and underside of a snap-link coupling for use in a workbench herein as shown in its unsnapped position;

FIGS. 19a to 19c show sectional views from the side of the snap-link coupling of FIGS. 18a and 18b, as respectively shown in the locked, unlocked and unsnapped positions;

FIG. 20 shows a perspective view of the top of a clamp that is a slight variant of the clamp of FIGS. 13 to 17d, as shown in the clamp closed position.

### DETAILED DESCRIPTION

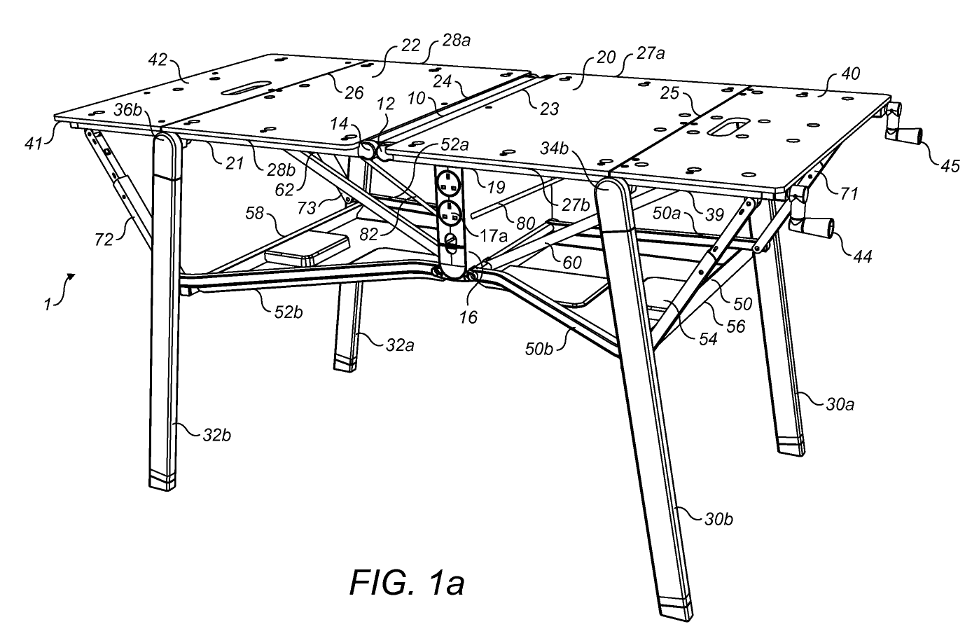

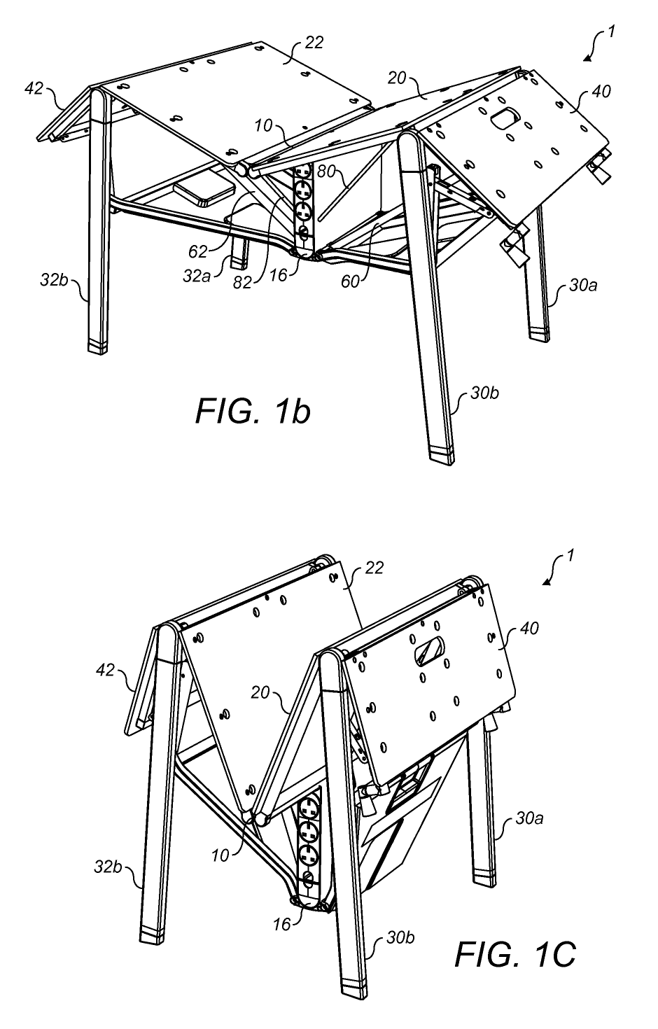

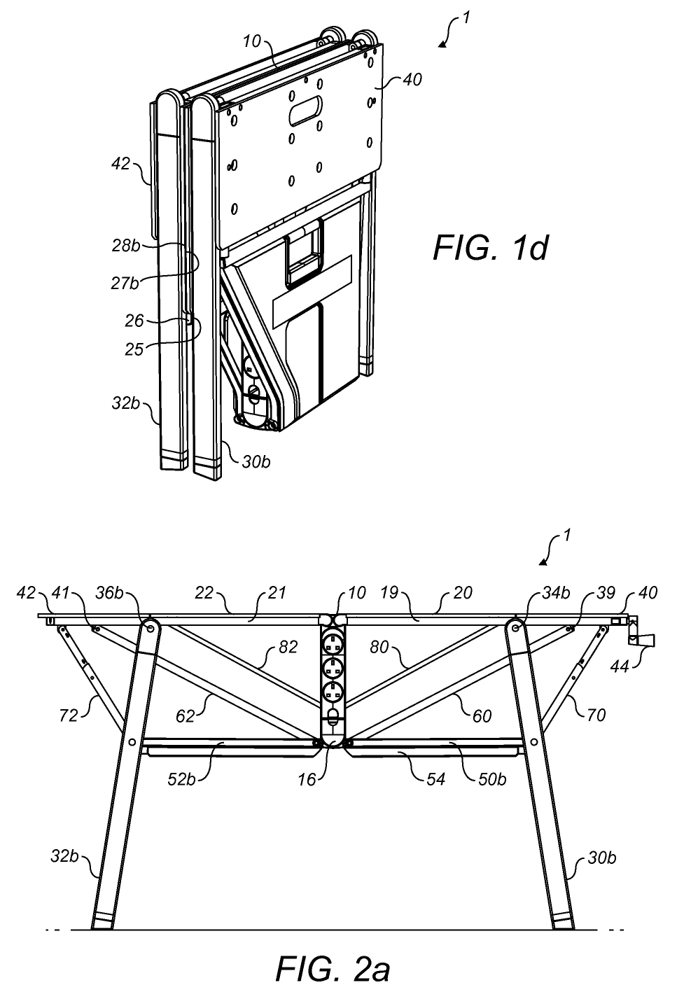

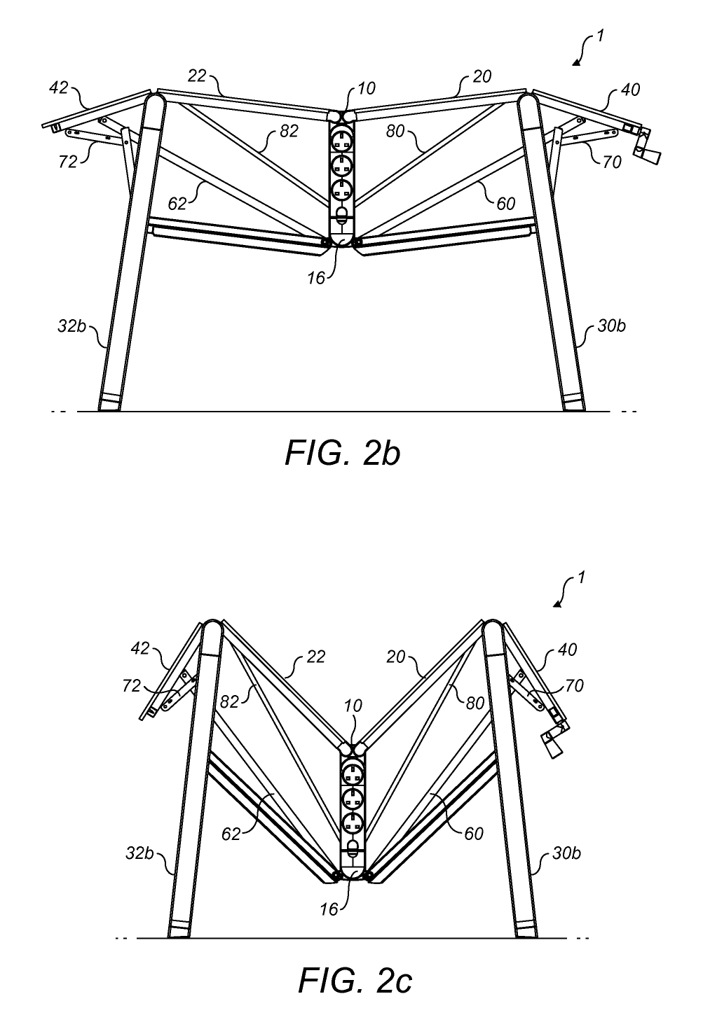

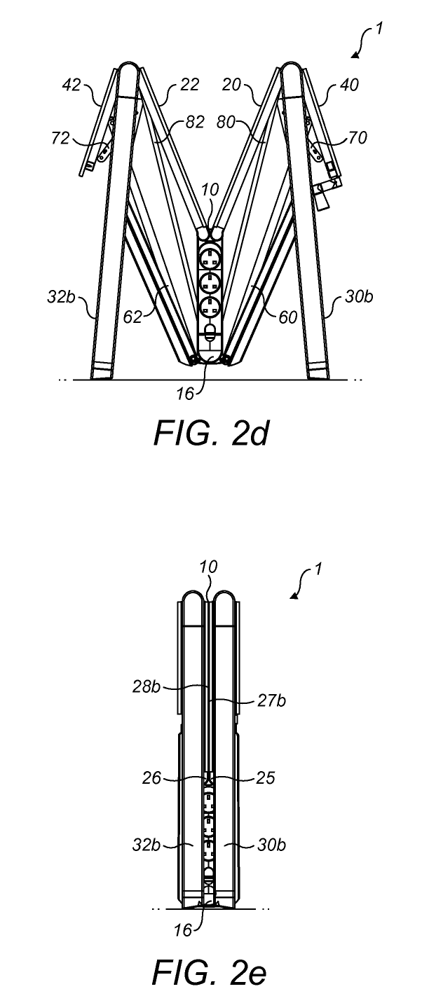

Referring now to the drawings, in FIGS. 1a to 1d; and FIGS. 2a to 2e there is shown a first folding workbench 1 herein in various stages as the workbench is folded up from a normal ‘in-use’ configuration (FIGS. 1a and 2a), in which the workbench rests on the floor, to a normal ‘folded’ configuration (FIG. 1d and 2e). For simplicity of reference, not all Figures are labelled with all number labels.

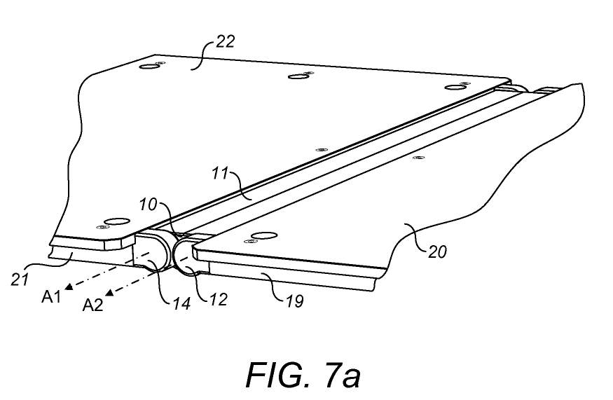

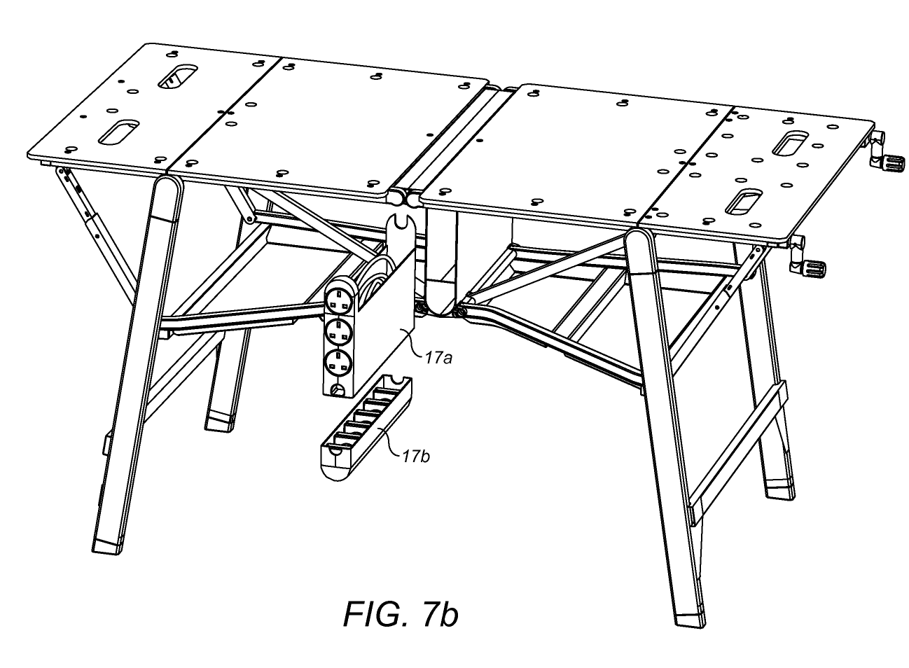

In more detail, and with further reference to FIG. 7a, the workbench 1 comprises a rigid central spine 10, defining first and second spaced hinge mountings 12, 14 arranged in parallel fashion. First and second primary work surfaces 20, 22 attached to first and second primary work surface frames 19, 21 (see FIG. 7) hingedly mount to the central spine 10 via said first and second hinge mountings 12, 14. The central spine 10 is provided with a top surface 11 in the form of a rectangular plate, which in this (i.e. in the in-use) configuration is essentially co-planar with the top surfaces of the first and second primary work surfaces 20, 22. It will be noted that the hinge axes A1, A2 defined by the hinge mountings 12, 14 are parallel to each other and to a central axis defined by the central spine 10 and lie below the plane of the rectangular plate 11.

Each work surface frame has an inner edge 23, 24, an outer edge 25, 26 and two side edges 27a, 27b; 28a, 28b. It may be seen that it is the inner edge 23, 24 of each primary work surface frame 19, 21 that hingedly mounts to the central spine 10 such that the primary work surface frames 19, 21 (and their respectively supported work surfaces 20, 22) are foldable towards each other.

As a point of detail, it is noted that each hinge mounting 12, 14 for the primary work surface frames 19, 21 locates approximately 20 mm away from the centre line of the workbench 1 to allow the frame 19, 21 to rotate clear of the central spine 10 and allow the primary work surfaces 20, 22 to meet flush along the centre line.

The workbench additionally comprises two opposing pairs of legs 30a, 30b; 32a, 32b. Each leg 30a, 30b; 32a, 32b mounts via pivot mounting 34b, 36b to one end of the outer edge 25, 26 of the first and second primary work surface frames 19, 21 such that the legs of each opposing pair 30a, 30b; 32a, 32b are foldable towards each other.

The workbench 1 also includes first and second subsidiary work surface frames 39, 41, which support first and second subsidiary work surfaces 40, 42. Second subsidiary work surface frame 41 pivotally mounts directly to outer edge 26 of the second primary work surface frame 21. First subsidiary work surface 40 mounts via slide track mounting to first subsidiary work surface frame 39, which then pivotally mounts to outer edge 25 of the first primary work surface frame 19. The first subsidiary mount surface 40 is movable on its slide track mounting by the action of turn handles 44, 45. It may also be seen that trunk 16 extends downwards from the central spine 10. The trunk 16 defines an inner cavity for receipt of electrical socketry 17a and also cabling, tools etc., as shown in more detail in FIG. 7b, and a storage drawer 17b.

As a point of detail, it is noted that the exact positioning of the pivot mountings for the subsidiary work surface frames 39, 41 lies about 10 mm below the corresponding edge of the frame 39, 41.

Struts 50a, 52a, 50b 52b pivotally connect the underside of the trunk 16 to each of the respective legs 30a, 30b; 32a, 32b such that in the in-use configuration the struts 50a, 52a, 50b 52b define a tray framework for receipt of storage tray 54. Leg cross-struts 56, 58 are also provided to adjacent legs 30a, 30b and 32a, 32b respectively, each leg cross-strut 56, 58 running parallel to the respective outer edge 25, 26 of one of the first and second primary work surface frames 19, 21. The leg cross-struts 56, 58 provide further support for the tray 54.

The workbench 1 also comprises first and second coupling arms 60, 62 that act to respectively couple trunk 16 to the underside of each of the first and second subsidiary work surface frames 39, 41.

As may be seen with particular reference to FIGS. 1b-1c and 2b-2d, during folding the first and second couplings 60, 62 act such as to pull the respective underside of each of the first and second subsidiary work surface frames 39, 41 parallel with the respective underside of each of the first and second primary work surface frames 19, 21.

Two supports 70, 71 are provided to support the first subsidiary work surface frame 39 in the in-use configuration. These two supports 70, 71 extend upwards from adjacent pair of legs 30b, 30a. Similarly, two supports 72, 73 are provided to support the second subsidiary work surface frame 41 in the in-use configuration. Again, these two supports 72, 73 extend upwards from adjacent pair of legs 32b, 32a.

Each of the supports 70-73 comprises a snap-link provided with a lock for locking said link to provide rigid support when the first and second subsidiary work surface frames 39, 41 are in the in-use configuration.

First and second sprung couplings 80, 82 act to respectively couple trunk 16 to the underside of each of the first and second primary work surface frames 19, 21. These sprung couplings 80, 82 act such as to provide a degree of resistance to folding (and hence control and safety) when the workbench 1 is folded up and provide a degree of spring assist when the workbench 1 is unfolded.

Referring in particular to FIGS. 1d and 2e it may be seen that in the folded configuration the outer edges 25, 26 of the respective first and second primary work surfaces 20, 22 rest flush with each other and each of the legs 30b, 32b (only two visible in FIGS. 1d and 2e) rests flush with a side edge 27b, 28b (again, only two visible in FIGS. 1d and 2e) thereof.

Also, in the folded configuration, each respective subsidiary work surface frame 39, 41 rests parallel with its primary work surface frame 19, 21 and flush with the relevant legs 30a, 30b, 32a, 32b. The trunk 16 locates directly underneath the first and second primary work surfaces 20, 22. It may be seen that the combined length of the trunk 16 add to the length of one of the side edges 27b, 28b of the first and second primary work surfaces 20,22 amounts to just less than the length of one of the legs 30b, 32b.

It may be appreciated that the overall form of the workbench 1 is generally symmetrical about the central spine 10. Such symmetry is desirable from the standpoint of ease and stability of use, particularly during folding and unfolding of the workbench 1.

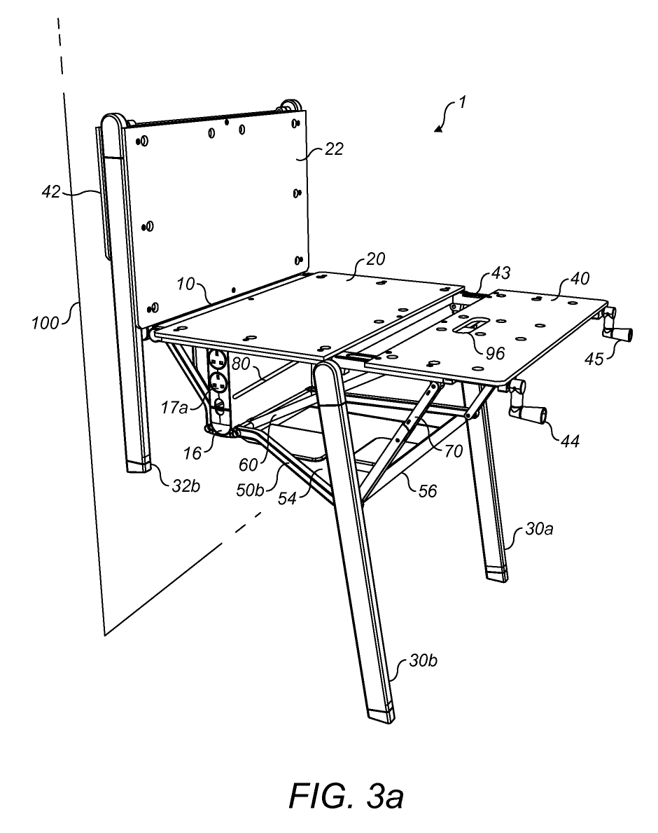

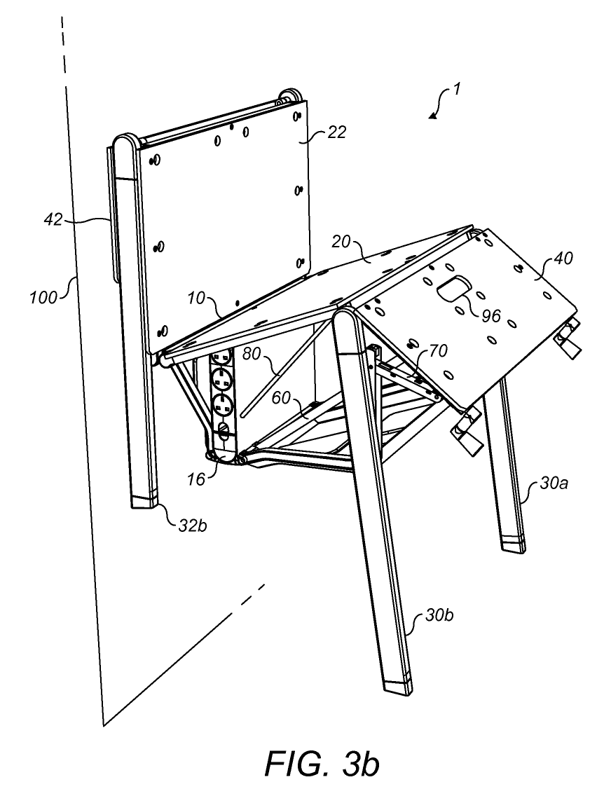

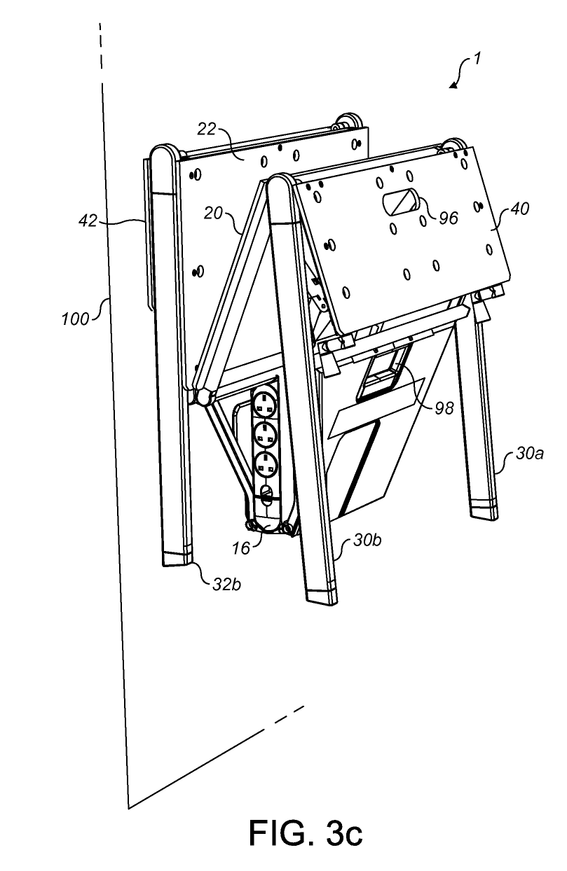

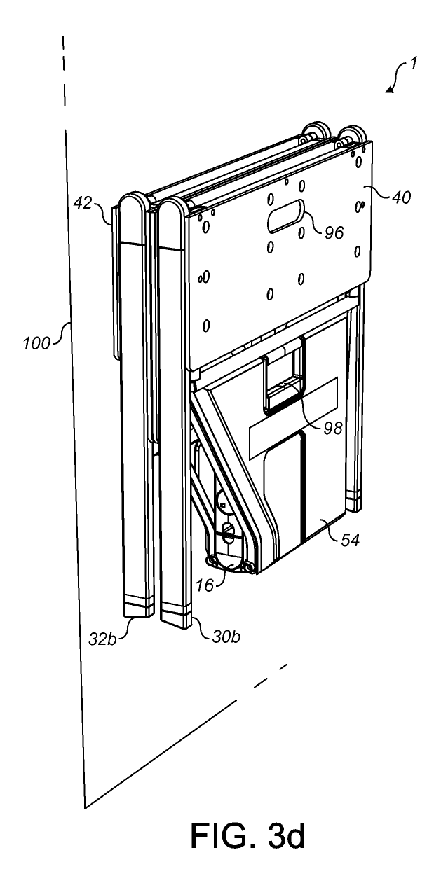

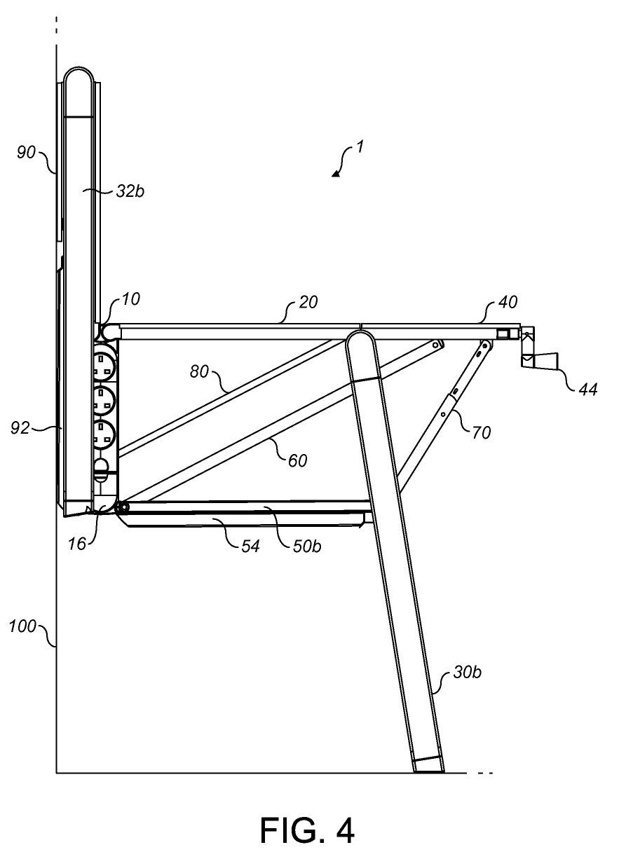

It is however, also a feature of the workbench 1 herein that it may be used in an asymmetrical mode of operation in which it is used in combination with a wall mounting suitable for mounting one half of the workbench in its folded configuration whilst the other half is in the in-use configuration. FIGS. 3a to 3d and 4 show the workbench 1 herein in various stages as the workbench 1 is folded up from the wall-mounted ‘in-use’ configuration (FIG. 3a and FIG. 4) to the wall-mounted ‘folded’ configuration (FIG. 3d).

Referring now to FIGS. 3a to 3d and FIG. 4, the general features of the workbench 1 and mode of operation thereof are identical to those already described with reference to FIGS. 1a to 1d; and FIGS. 2a to 2e. For succinctness, features already described with reference to the earlier drawings are not described further hereinafter.

In one embodiment, the left hand-side of the workbench 1 mounts to the wall 100 via mounting brackets 90, 92 provided to the wall that engage with mounting slots 96, 98 provided respectively to the top of the second subsidiary work surface frame 41 and the underside of the tray 54. These mounting slots 96, 98 are visible in FIG. 3d, but in respect of the unmounted half of the workbench 1. First subsidiary work surface 40 mounts to its first subsidiary work surface frame 39 by a slide track mounting 43 and is movable thereon by the action of turn handles 44, 45 to form a ‘vice’ like feature.

The wall-mounted mode of operation is particularly suitable for use in restricted spaces and where the full extent of the workbench top surface is not required.

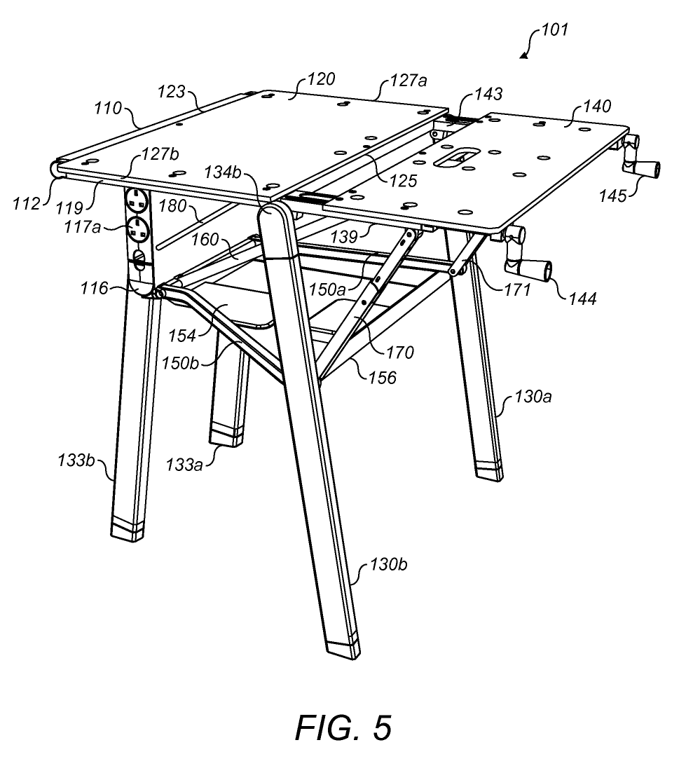

FIG. 5 shows a second workbench herein that may be appreciated to be a variation of the first workbench of FIGS. 1a to 4, which in essence comprises only ‘one half’ of the first workbench 1 together with an additional pair of supporting legs 133a, 133b provided to the underside of the trunk 116 thereof.

In more detail, the second workbench 101 comprises a rigid spine 110 provided with first hinge mounting 112 arranged in parallel fashion thereto. First primary work surface frame 119 hingedly mounts to the spine 110 via said first hinge mounting 112. The primary work surface has an inner edge 123, an outer edge 125 and two side edges 127a, 127b. It may be seen that it is the inner edge 123 of the primary work surface 120 that hingedly mounts to the spine 110 such that the primary work surface 120 (and its respective supporting frame 119) is foldable up.

The workbench 101 comprises first pair of legs 130a, 130b. Each of these legs 130a, 130b mounts via pivot mounting 134b to one end of the outer edge 125, of the first primary work surface frame 119 such that the legs 130a, 130b are foldable in.

The workbench 101 also includes first subsidiary work surface 140, which mounts via slide track mounting 143 to first subsidiary work surface frame 139, which then pivotally mounts to outer edge 125 of the first primary work surface 120. The first subsidiary mount surface 140 is movable on its slide track mounting by the action of turn handles 144, 145. It may also be seen that trunk 116 extends downwards from the spine 110. The trunk 116 defines an inner cavity for receipt of electrical socketry 117 and also cabling, tools etc. The underside of the trunk 116 is further provided with an additional pair of supporting legs 133a, 133b.

As a point of detail, it is noted that the exact positioning of the pivot mounting for the subsidiary work surface frame 139 lies about 10 mm below the corresponding edge of the frame.

Struts 150a, 150b pivotally connect the underside of the trunk 116 to each of the legs 130a, 130b such that in the in-use configuration the struts 150a, 150b define a tray framework for receipt of storage tray 154. Leg cross-strut 156 is also provided to adjacent legs 130a, 130b, the leg cross-strut 156 running parallel to the outer edge 125 of one of the first primary work surface 120. The leg cross-strut 156 provides further support for the tray 154.

The second workbench 101 also comprises first coupling arm 160 that acts to couple trunk 116 to the underside of the first subsidiary work surface frame 139.

As with first workbench 1, during folding of the second workbench 101 the first coupling 110 acts such as to pull the underside of the first subsidiary work surface frame 139 parallel with the underside of the first primary work surface frame 119.

Two supports 170, 171 are provided to support the first subsidiary work surface frame 139 in the in-use configuration. These two supports 170, 171 extend upwards from adjacent pair of legs 130b, 130a. Each of the supports 170, 171 comprises a snap-link provided with a lock for locking said link to provide rigid support when the first subsidiary work surface frame 139 is in the in-use configuration.

First sprung coupling 180 acts to couple trunk 116 to the underside of the first primary work surface frame 119. This sprung coupling 180 acts such as to provide a degree of resistance to folding (and hence control and safety) when the workbench 101 is folded up and provides a degree of spring assist when the workbench 101 is unfolded.

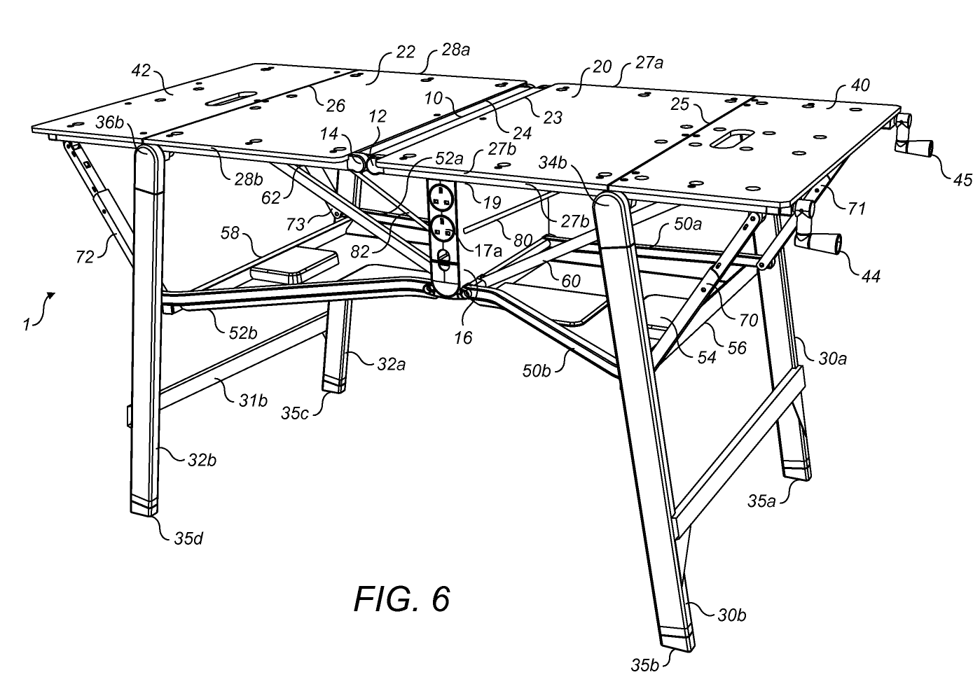

FIG. 6 shows a third folding workbench that is identical to the first folding workbench shown at FIGS. 1a to 1d and 2a to 2e hereinbefore other than that it further includes leg cross-bracing and rubber feet. Thus, all other labelled features of the third folding workbench are generally identical (except that storage tray 54 is moulded to fit around and behind leg cross-brace 31a, 31b) to those of the first folding workbench of FIGS. 1a to 1d and 2a to 2e, and the description of these is not repeated.

Whilst FIG. 6 shows the third folding workbench in the normal ‘in-use’ configuration, it will be appreciated that its folding action is identical to that of the first folding workbench of FIGS. 1a to 1d and 2a to 2e.

FIG. 6 shows the additional features of the third folding workbench, namely that respective adjacent pairs of legs 30a, 30b and 32a, 32b are each provided with a respective cross-brace 31a, 31b. The presence of the cross-braces 31a, 31b adds to the stability of the workbench. Rubber feet 35a-d are also provided to each leg 30a, 30b, 32a, 32b.

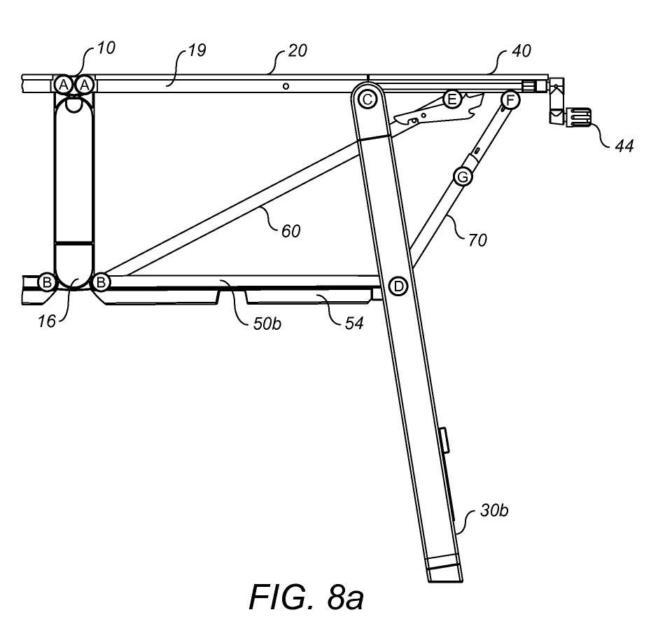

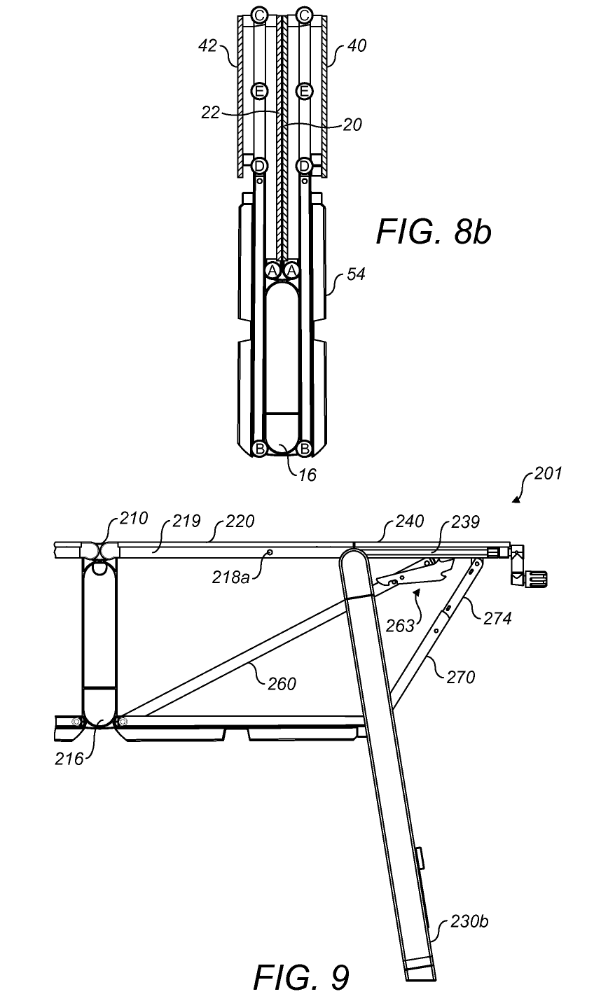

FIGS. 8a and 8b show schematic end views of the arrangement of pivots of one half of the first folding workbench 1 of FIGS. 1a to 2e respectively in its in-use and folded configurations. The workbench 1 is shown absent its legs and with its tray 54 in ghosted view in FIG. 8b for clarity of view. Other than the now-labelled pivots A to G, all other labelled features are identical to those of the first folding workbench of FIGS. 1a to 2e, and the description of these is not repeated.

In more detail, and with particular reference to FIG. 8a, pivots A, B, C and D may be seen to adopt the form of a parallelogram frame, and with the identical pivot arrangement of the other half of the workbench (not shown in FIG. 8a, but see FIGS. 1a to 2d) therefore adopt an overall back-to-back parallelogram frame arrangement that is symmetrical about the trunk 16. This back-to-back parallelogram structure provides the workbench 1 with strength, and assists with ease of folding/unfolding.

The pair of pivots A may be seen to lie equally spaced about the central spine 10, inboard thereof and also inboard of the walls defining the trunk 16. The pair of pivots B are also equally spaced, but with spacing greater than that of pair of pivots A and lying outboard of the walls defining the trunk 16.

Now referring to FIG. 8b, when the workbench 1 is in the folded-up configuration, pivots A remain spaced and side-by-side and pivots C, E, D and B may be seen to line up approximately in a straight line. Overall, it will be appreciated that the arrangement of pivots A to G is selected to maximise the compactness of the folded-up configuration and to enable ease of its transition to and from the in-use configuration.

As has been described in relation to the previous figures, the workbench 1; 101 herein suitably comprise coupling arms 60, 62; 160 that act to respectively couple trunk 16; 116 to the underside of each of the first and second subsidiary work surface frames 39, 41; 139. In embodiments, each of the coupling arms 60, 62; 160 is provided with a safety catch, which acts to prevent uncontrolled (or e.g. accidental) folding of the frame assembly of the workbench. One such embodiment is now described with particular reference to FIGS. 9 to 12c.

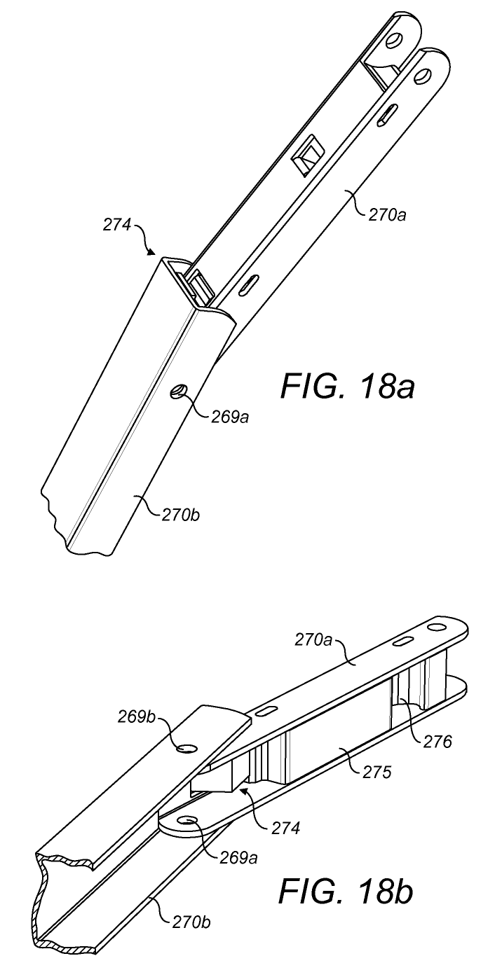

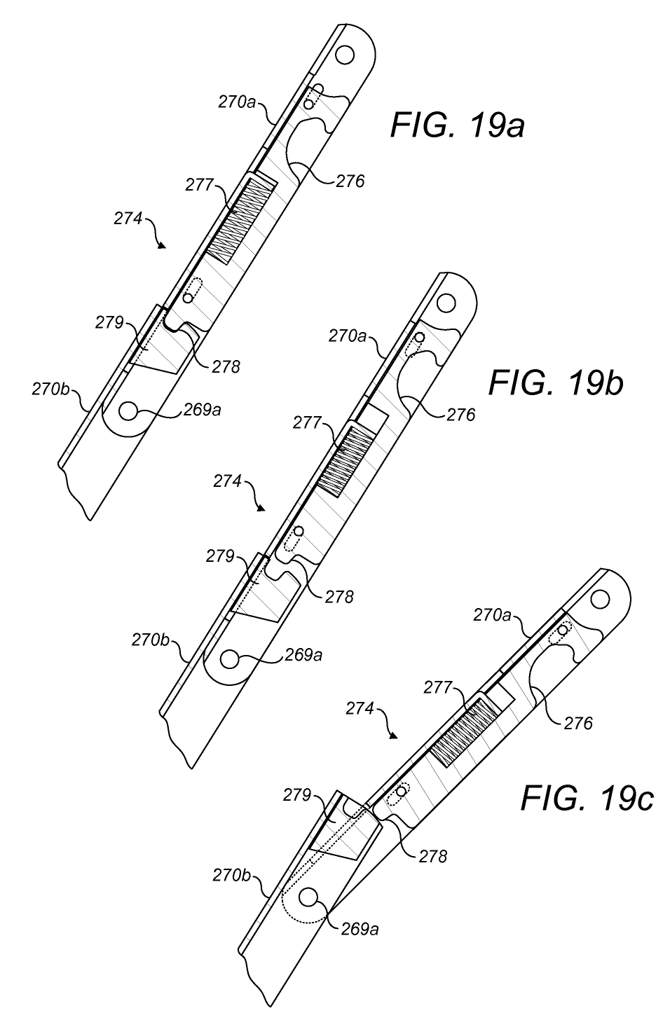

Thus, FIG. 9 shows one-half of a fourth folding workbench 201 herein with a safety catch feature 263 provided to a coupling arm 260 thereof. As before, the coupling arm 260 acts such as to couple trunk 216 to the underside of first subsidiary work surface frame 239. The workbench 201 also includes supports 270 (only one visible) to support the first subsidiary work surface frame 239 in the in-use configuration. Second latch pins 218a (only one visible) are provided to the primary work surface frame 219. The supports 270 extend upwards from adjacent pair of legs 230b (only one visible). Each of the supports 270 comprises a snap-link lock 274 (see also FIGS. 18a to 19c) for locking said link to provide rigid support when the first subsidiary work surface frame 239 is in the in-use configuration. Other details of the workbench 201 including first primary work surface frame 219; first primary work surface 220; and first subsidiary work surface 240; are generally identical in form to those already described in relation to the first to third workbenches herein (other than that the number of access holes 246a, 246b has changed from one to two).

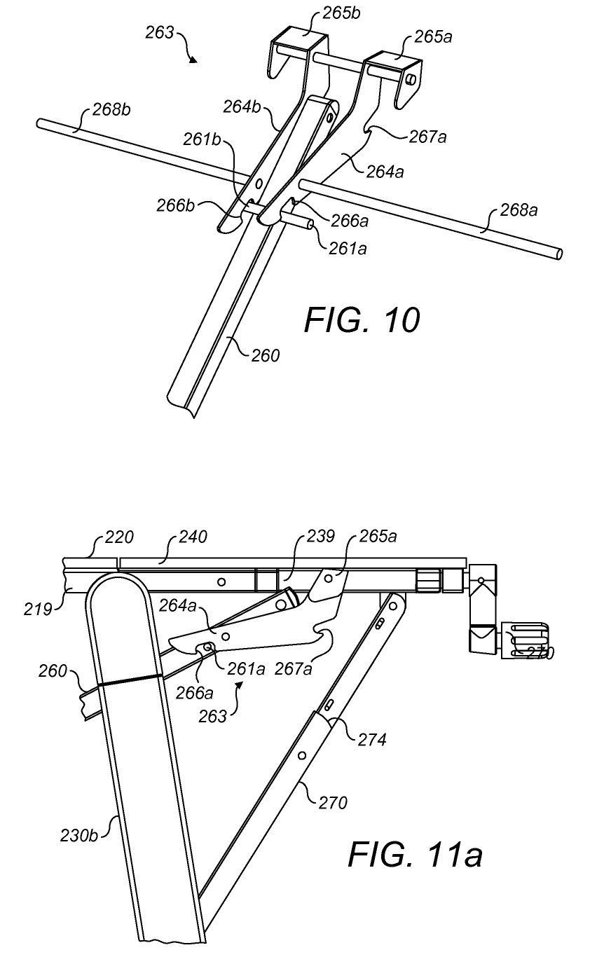

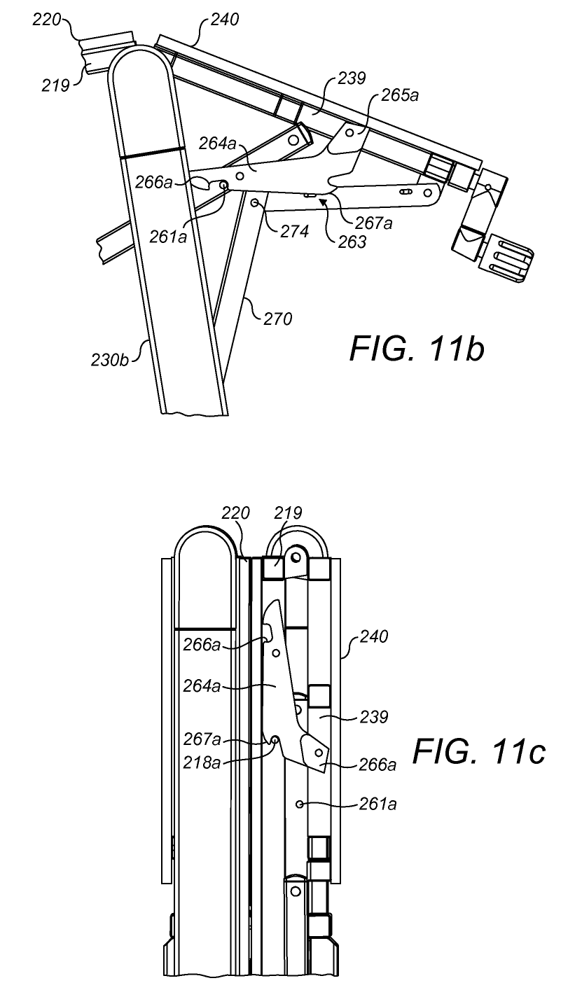

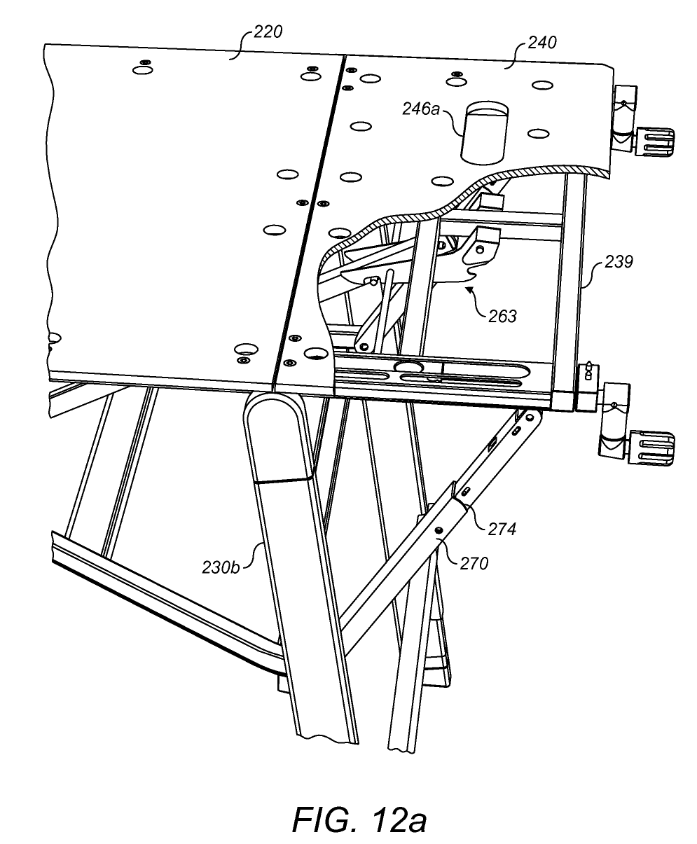

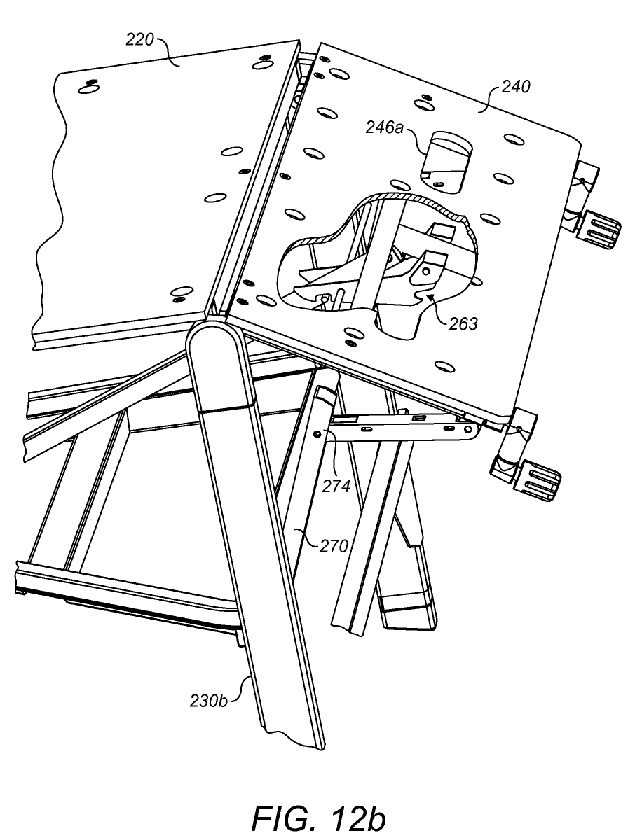

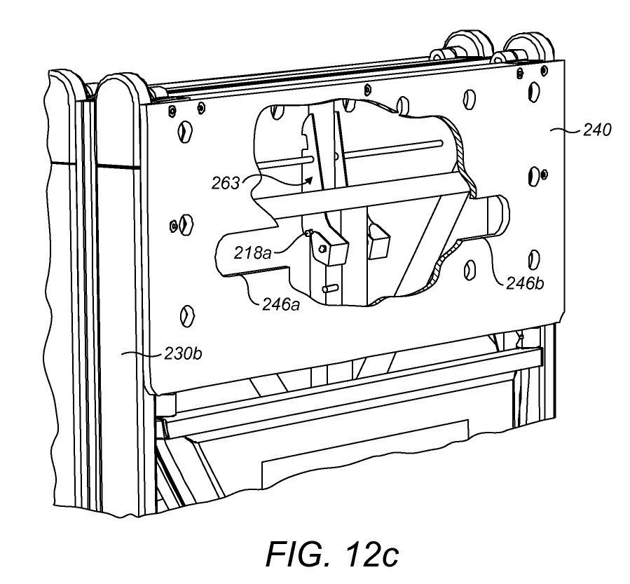

FIG. 10 shows more details of the safety catch feature 263, which comprises first and second latch arms 264a, 264b, which pivotally mount to the underside of the first subsidiary work surface frame 239 by means of pivot mountings 265 a, 265b. It will be appreciated that both latch arms 264a, 264b share a common axis of pivot mounting 265a, 265b. Each latch arm 264a, 264b is provided with a first latch element 266a, 266b in the form of a cutaway portion for latching interaction with first latch pins 261 a, 261b provided to the coupling arm 260 when the workbench is in the in-use configuration (see also FIGS. 11a and 12a) and a part-folded configuration (see FIGS. 11b and 12b). Each latch arm 264a, 264b is provided with a second latch element 267a (second latch element of second latch arm 264b, not visible) in the form of a cutaway portion for latching interaction with the second latch pins 218a, 218b when the workbench is in the folded configuration (see also FIGS. 11c and 12c).

Each latch arm 264a, 264b is further provided with an actuator arm 268a, 268b in the form of a horizontally extending rod, which actuator arm 268a, 268b is arranged for ease of latching/de-latching by the user. It will be appreciated that the actuator arms 268a, 268b share the same axis when the latch arms 264a, 264b are both latched in the in-use (see FIGS. 11a, 12a) and/or folded (see FIGS. 11c, 12c) configurations of the workbench 201.

Further details of the latch arm 264a, 264b action may be understood by reference to FIGS. 11a to 11c and 12a to 12c.

Referring now to FIGS. 11a and 12a, the workbench 201 is shown in the in-use configuration. The snap-link lock 274 of the supports 270 (only one visible) is locked in place, and folding up of the first subsidiary work surface frame 239 is therefore not possible. The first latch elements 266a (only one visible) of the latch arms 264a (only one visible) rest firmly on the first latch pins 261 a (only one visible) of the coupling arm 260 as a result of the latching arms 264a, 264b being sprung about their pivots.

Referring now to FIGS. 11b and 12b, the snap-link lock 274 of the support has now been unlocked and folding up of the first subsidiary work surface frame 239 (and hence, workbench 201 as a whole) is in progress. The coupling arm 260 is however still latched into its position, and the workbench 201 may not be folded up further without first unlatching the latch 263. That unlatching is achieved by the user reaching through access holes 246a, 246b to pull up on the actuator arms 268a, 268b and to thereby manipulate the latch arms 264a, 264b to unlatch first latch elements 266a, 226b from the first latch pins 261a, 261b of the coupling arm 260. Once so-unlatched the coupling arm 260 may be moved freely to the fully folded position of FIGS. 11c and 12c, in which the second latch elements 267a, 267b latch onto their respective second latch pins 218a (only one visible). During this further folding the coupling arm 260 acts such as to pull the underside of the first subsidiary work surface frame 239 flush with the respective underside of the first primary work surface frame 219.

In a subtle aspect, and with particular reference to FIG. 12b, it may be noted that for the full folding action to occur the user must first reach through the access holes 246a, 246b with both hands thereby, ensuring that both of the user's hands are free of the folding action. The user's hands are also in the correct position to take the weight of the workbench 201 as it closes. This therefore provides a safety benefit in that any accidental crushing of the user's hands is prevented because the hands are safely located within the access holes 246a, 246b during the folding action. The actuator arms 268a, 268b are again used by the user in similar fashion as described to unlock the workbench 201 from the fully folded position of FIGS. 11c and 12c and to enable unfolding thereof.

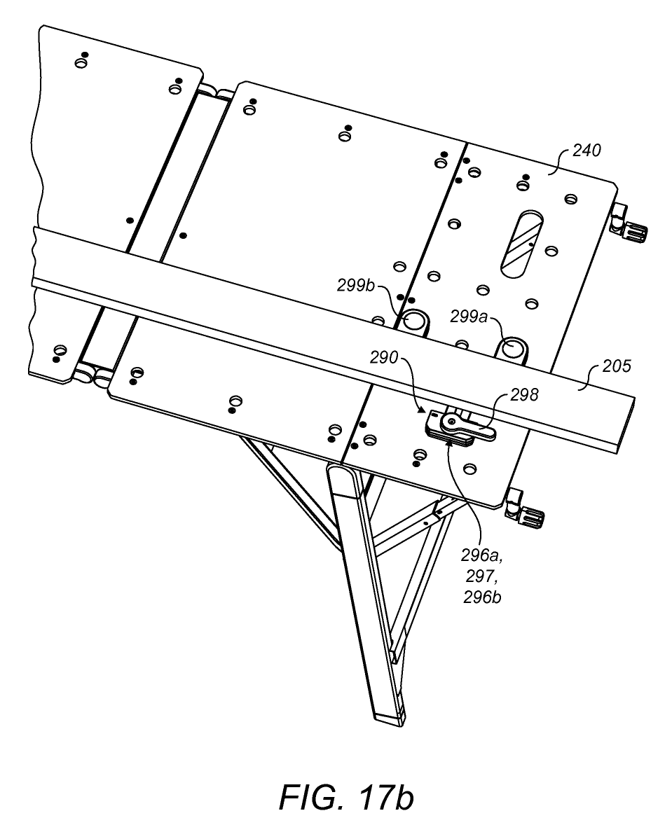

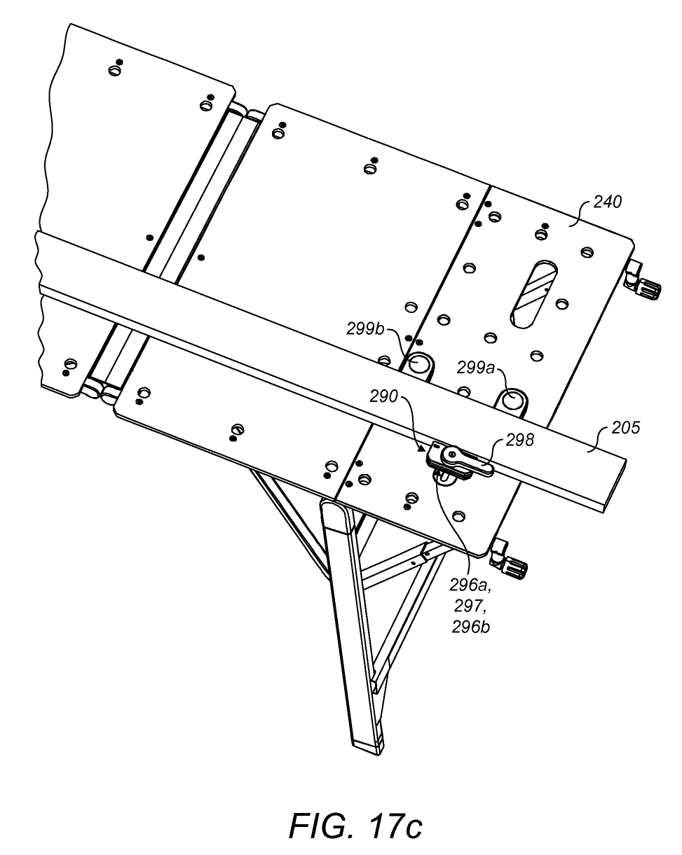

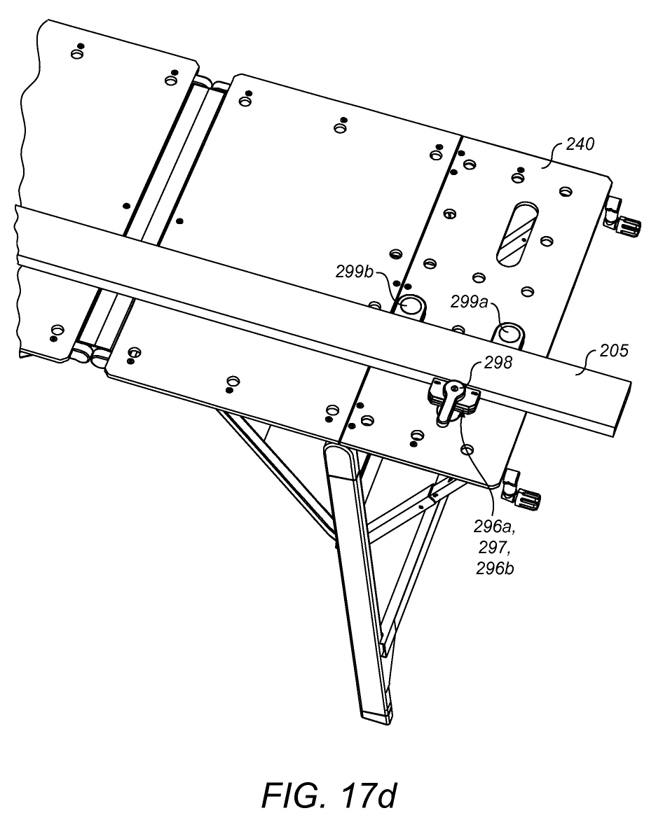

The workbench 1; 101; 201 herein is in embodiments, provided with a clamp 290 for reversible clamping of a wooden plank or other item to be worked on. The clamp 290 is now described in particular relation to its use with the fourth workbench 201 herein (see FIGS. 17a to 17d), although it may be appreciated that its form makes it amenable for use with any of the workbenches 1; 101; 201 described herein.

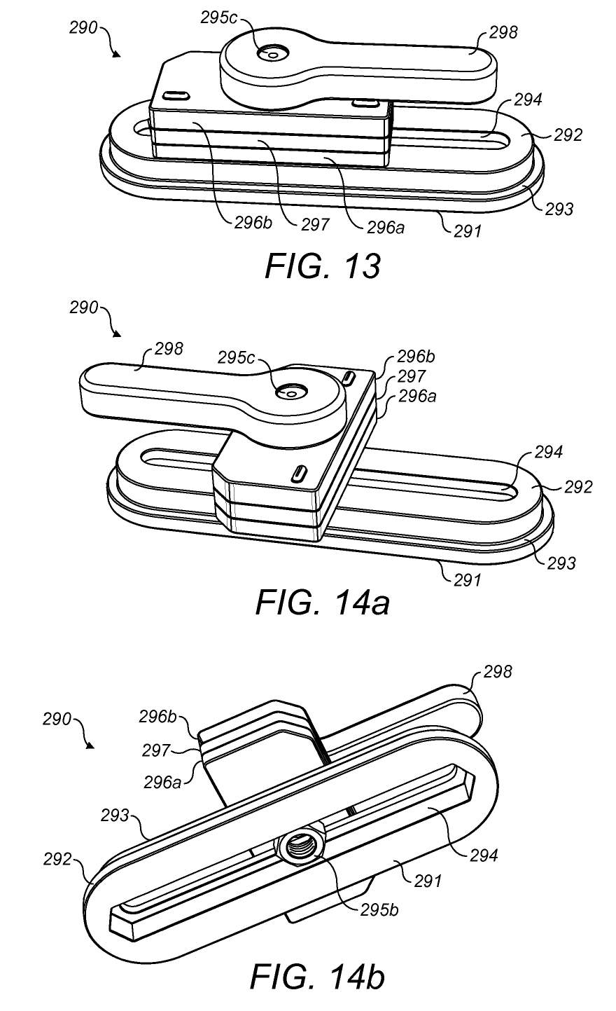

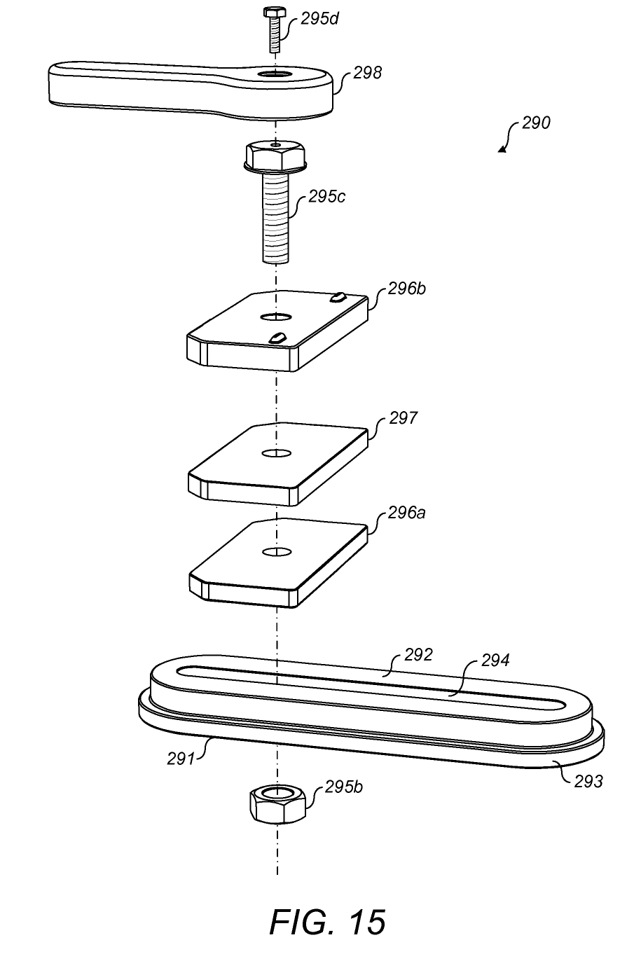

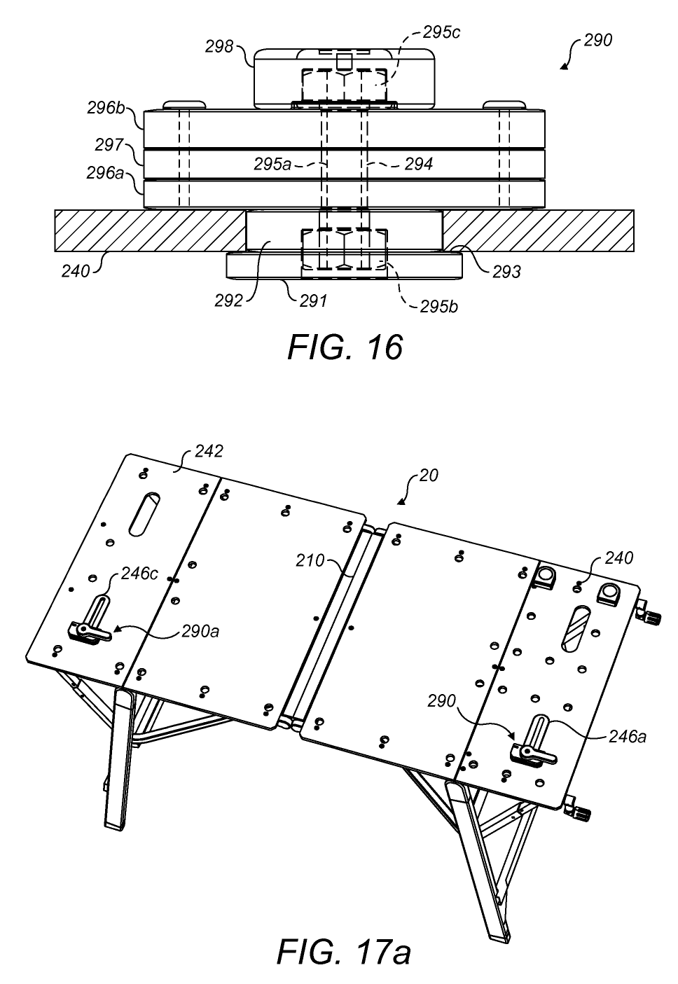

Referring now to FIGS. 13 to 16, there is shown a clamp 290 comprising a base 291 defining an upper plug 292 portion sized and shaped for receipt within an access hole 246a, 246b of a subsidiary work surface 240 of the workbench 201. The base 291 is provided with a flange 293, which in-use seats against the underside of the subsidiary work surface 240, 242 when the plug portion 292 seats within the access hole 246a, 246b. The plug 292 includes a lateral slot 294 arranged for receipt of securing bolt 295 a, which is used to secure a sequential arrangement of lower jaw 296a; compressible rubber block 297; and upper jaw 296b to the base 291. It will be seen that securing nut 295b associates with securing bolt 295a to allow reversibly securable receipt of the arrangement 296a, 297, 296b within the slot 292.

It will also be seen that handle 298 is received by the head 295c of the securing bolt 295a and that handle-retaining bolt 295d is used to secure the handle 298 to the head 295c of the securing bolt 295a. It will be appreciated that in use, the handle 298 is turned to cause a loosening of the securing bolt 295c, which enables the jaw and block arrangement 296a, 297, 296b to be moved laterally within the slot 294.

FIG. 13 shows the clamp 290 in an unsecured position, in which the shank of the handle 298 and jaw and block arrangement 296a, 297, 296b are lined up with the base 291. FIGS. 14a and 14b show the clamp 291 in a secured position, in which the jaw and block arrangement 296a, 297, 296b has been turned through 90 D and the handle 298 has been turned through a further 90 D (i.e. a quarter turn) relative to the base 291 to allow for securing of the jaw and block arrangement 296a, 297, 296b at a particular lateral position within the slot 294 of the base 291.

Referring now to FIGS. 17a to 17d, which show sequential steps in securing a plank of wood to clamps 290, 290a provided to a workbench 201 herein.

At FIG. 17a, it may be seen that a first clamp 290 has been secured within an access hole 246a of first subsidiary work surface 240, and a second clamp 290a has been secured within an oppositely-located access hole 246c of second subsidiary work surface 242. Both clamps 290, 290a are in the loosened position, in which the handle 298 thereof is orthogonal to the central axis defined by the central spine 210 of the workbench 201. The jaw and block arrangement 296a, 297, 296b lines up with the handle 298.

At FIG. 17b, dogs 299a, 299b have been provided to the first subsidiary work surface 240, and are received in holes provided thereto. The dogs 299a, 299b locate in line with each other and spaced from the jaw and block arrangement 296a, 297, 296b of the clamp 290 such that wooden plank 205 may be received therebetween.

At FIG. 17c, the jaw and block arrangement 296a, 297, 296b has been moved within the slot 294 of the clamp 290 towards the wooden plank 205 such that the edges of the wooden plank 205 sandwich snugly between the dogs 299a, 299b and the jaw and block arrangement 296a, 297, 296b of the clamp 290.

At FIG. 17d, the clamp 290 has been tightened by turning the handle 298 through 90° (i.e. a quarter turn) relative to its base 291. This tightening results in securing of the jaw and block arrangement 296a, 297, 296b at the selected lateral position within the slot 294 of the base 291. The tightening also results in a slight compression of the rubber block 297 within the first 296a and second blocks 297a, thereby causing the rubber block to bulge slightly, which bulging results in tight gripping of the wooden plank 205.

It will be appreciated that untightening and removal of the wooden plank from the clamp 290 may be achieved by carrying out the steps of FIGS. 17a to 17d in reverse order.

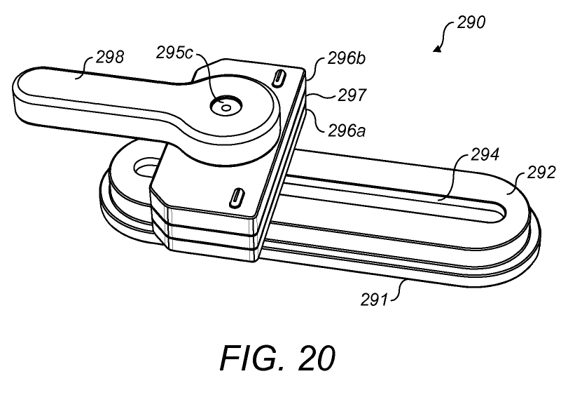

A variant of the clamp 290 of FIGS. 13 to 17d is shown at FIG. 20. This variant is identical to the earlier clamp in all aspects other than that the flange 293 of the earlier clamp 290 is not present.

As has been described in relation to the previous figures, the workbench 1; 101; 201 herein suitably comprise support arms 70-73; 170-171; 270 that are provided to support the first and/or subsidiary work surface frames 39, 41; 139; 239 in the in-use configuration. In embodiments, each of the 70-73; 170-171; 270 comprises a snap-link lock 274 for locking thereof to provide rigid support when the first and/or subsidiary work surface frames 39, 41; 139; 239 are in the in-use configuration. Details of one such snap-link lock 274 are now described with particular reference to FIGS. 18a to 19c.

Referring initially to FIGS. 18a and 18b, there is shown first and second 270a, 270b halves of support, which pivot mount relative to each other at pivot points 269a, 268b, and are provided with snap-link lock 274.

The mechanism of the snap-link lock 274 may be better understood by reference also to FIGS. 19a to 19c. Thus, first support half 270a is provided with slide mounted latch 275, which includes finger-accessible release element 276 (in the form of a recess).

As shown at FIG. 19a, the latch 275 is biased by spring 277 such that a lock finger 278 thereof is biased into latching engagement with a notched element 279 of the second support half 270b. The supports 270a, 270b are thereby, locked into engagement with one another.

As shown at FIG. 19b, the user has pulled back on the release element 276 to slide the latch 275 back against the biasing force of the spring 277 such that the lock finger 278 has become disengaged from the notched element 279. The support halves 270a, 270b are thereby, unlocked from their engagement with one another, and the support halves 270a, 270b may be ‘snapped open’ by relative movement about the pivots 269a, 269b to the unsnapped position of FIG. 19c.

It will be appreciated that return of the support halves 270a, 270b to the locked position may be readily achieved by carrying out the steps of FIGS. 19a to 19c in reverse order. In aspects the opening action of the workbench 201 and springs 277 automatically put the snap-links 274 into the locked position with the user merely having to do a quick visual inspection to ensure that all snap-links 274 are locked.

For the avoidance of doubt, it is noted that wherever reference herein is made to ‘pivot mounting’, ‘pivotally mounting’, pivotally connecting’ and the like, what is envisaged is both classic pivot forms typically comprising pivot pins and associated bushes and washers, and any functional equivalents thereto such as pivot assemblies that comprise interlocking parts that provide the required pivot movement.

It is noted that wherever reference herein is made to ‘hinge mounting’, ‘hingedly mounting’, hingedly connecting’ and the like, what is envisaged is both classic hinge forms and any functional equivalents thereto such as hinge assemblies that comprise interlocking parts that provide the required hinge movement.

What is claimed is:

1. A frame assembly for a workbench that is reversibly foldable from an in-use to a folded configuration comprising:
a central spine;
first and second primary work surface frames, each work surface frame having an inner edge, an outer edge and two side edges, wherein each said inner edge thereof hingedly mounts to the central spine such that the primary work surface frames are foldable towards each other; and
first and second opposing pairs of legs, each leg pivotally mounting to one end of an outer edge of the first and second primary work surface frames, such that the legs of each opposing pair are foldable towards each other,
wherein the inner edge of each of the first and second primary work surface frames hingedly mounts to the central spine by a distinct hinge mounting such that in the folded configuration, opposing side edges of the respective first and second primary work surface frames are brought parallel with each other and each of the legs is brought parallel with a side edge thereof.

2. A frame assembly for a workbench according to claim 1, additionally comprising first and/or second subsidiary work surface frames, each respective subsidiary work surface frame pivotally mounting to an outer edge of the first and second primary work surface frames, wherein in the folded configuration, each respective subsidiary work surface frame is brought parallel with its primary work surface frame.

3. A frame assembly for a workbench according to claim 2, wherein in the folded configuration, each respective subsidiary work surface frame is brought parallel with the legs.

4. A frame assembly for a workbench according to claim 1, wherein the central spine locates about the central folding axis for the frame assembly.

5. A frame assembly for a workbench according to claim 1, wherein the distinct hinge mountings locate inboard of the central spine.

6. A frame assembly for a workbench according to claim 1, wherein the central spine defines a rectangular top surface.

7. A frame assembly for a workbench according to claim 6, wherein in the in-use configuration said rectangular top surface defines a central work surface of the frame assembly.

8. A frame assembly for a workbench according to claim 6, wherein the distinct hinge mountings locate inboard of the rectangular top surface.

9. A frame assembly for a workbench according to any of claim 1, wherein the distinct hinge mountings are in parallel fashion to each other such as to define first and second hinge axes that are parallel to and spaced apart relative to each other.

10. A frame assembly for a workbench according to claim 9, wherein the relative spacing of the axes of the hinge mountings is selected to allow for compact folding of the frame assembly.

11. A frame assembly according to claim 9, wherein said first and second hinge axes lie below the central spine.

12. A frame assembly for a workbench according to claim 1, wherein a trunk extends downwards from the central spine.

13. A frame assembly for a workbench according to claim 12, wherein the distinct hinge mountings locate inboard of the trunk.

14. A frame assembly for a workbench according to claim 1, wherein:
the distinct hinge mountings are in parallel fashion to each other such as to define first and second hinge axes that are parallel to and spaced apart relative to each other;
a trunk extends downwards from the central spine; and
the first and second hinge axes of the distinct hinge mountings lie within an upper part of the trunk.

15. A frame assembly for a workbench according to claim 12, wherein in the folded configuration the trunk locates directly underneath the first and second primary work surface frames.

16. A frame assembly for a workbench according to claim 12, wherein the length of downward extent of the trunk added to the length of one of the side edges of the first and second primary work surface frames is less than or approximately equal to the length of one of the legs.

17. A frame assembly for a workbench according to claim 12, wherein struts pivotally connect a lower part of the trunk to each of the respective legs such that in the in-use configuration the struts define a tray framework for receipt of an optional tray.

18. A frame assembly according to claim 17, wherein leg cross-struts are provided to adjacent legs, each leg cross-strut running parallel to the outer edge of one of the first and second primary work surface frames.

19. A frame assembly according to claim 18, wherein said leg cross-struts further define said framework for receipt of an optional tray.

20. A frame assembly according to claim 12, wherein said trunk defines a trunk cavity for receipt of electrical equipment and/or tools.

21. A frame assembly for a workbench according to claim 1, additionally comprising:
first and/or second subsidiary work surface frames, each respective subsidiary work surface frame pivotally mounting to an outer edge of the first and second primary work surface frames, wherein in the folded configuration, each respective subsidiary work surface frame is brought parallel with its primary work surface frame;
a trunk extending downwards from the central spine; and
first and/or second couplings that act to respectively couple said trunk to the underside of each of the first and/or second subsidiary work surface frames.

22. A frame assembly for a workbench according to claim 21, wherein the or each of said first and/or second couplings acts such as to move the respective underside of each of the first and/or second subsidiary work surface frames parallel with the respective underside of each of the first and/or second primary work surface frames on folding the frame assembly from the in-use to the folded configuration.

23. A frame assembly for a workbench according to claim 21, wherein the or each of said couplings comprises a coupling arm.

24. A frame assembly for a workbench according to claim 21, wherein the or each of said couplings is provided with a safety catch.

25. A frame assembly for a workbench according to claim 24, wherein said safety catch comprises a latch arm, which pivotally mounts to the underside of the relevant subsidiary work surface frame, said latch arm provided with at least a first latch element for latching interaction with a first latch pin provided to the relevant coupling when the workbench is in the in-use configuration.

26. A frame assembly for a workbench according to claim 25, wherein the latch arm is additionally provided with a second latch element for latching interaction with a second latch pin provided to the relevant primary work surface when the workbench is in the folded configuration

27. A frame assembly for a workbench according to claim 25, wherein the safety catch comprises a pair of the latch arms.

28. A frame assembly for a workbench according to claim 27, wherein said pair of latch arms pivotally mount about a common pivot mounting axis.

29. A frame assembly according to claim 25, wherein the or each latch arm is provided with an actuator arm.

30. A frame assembly for a workbench according to claim 2, wherein one or more supports are provided to support either the first and/or second subsidiary work surface frames.

31. A frame assembly for a workbench according to claim 30, wherein said one or more supports extend from one or more of the legs or from any leg cross struts provided thereto.

32. A frame assembly for a workbench according to claim 30, wherein each of the one or more supports comprises a snap-link provided with a lock for locking said link rigid.

33. A frame assembly for a workbench according to claim 12, additionally comprising first and second sprung couplings act to respectively couple said trunk to the underside of each of the first and second primary work surface frames.

34. A frame assembly for a workbench according to claim 1, wherein the frame assembly is symmetrical about the central spine.

35. A frame assembly for a workbench according to claim 12, wherein the frame assembly adopts a back-to-back parallelogram frame arrangement that is symmetrical about the trunk.

36. A frame assembly for a workbench according to claim 1, wherein adjacent pairs of legs are provided with a cross-brace.

37. A workbench comprising a frame assembly that is reversibly foldable from an in-use to a folded configuration, the frame assembly having:
a central spine;
first and second primary work surface frames, each work surface frame having an inner edge, an outer edge and two side edges, wherein each said inner edge thereof hingedly mounts to the central spine such that the primary work surface frames are foldable towards each other; and
first and second opposing pairs of legs, each leg pivotally mounting to one end of an outer edge of the first and second primary work surface frames, such that the legs of each opposing pair are foldable towards each other,
wherein the inner edge of each of the first and second primary work surface frames hingedly mounts to the central spine by a distinct hinge mounting such that in the folded configuration, opposing side edges of the respective first and second primary work surface frames are brought parallel with each other and each of the legs is brought parallel with a side edge thereof, further comprising
first and second primary work surfaces provided to the first and second primary work surface frames.

38. A workbench according to claim 37, additionally comprising first and/or second subsidiary work surface frames, each respective subsidiary work surface frame pivotally mounting to an outer edge of the first and second primary work surface frames,
wherein in the folded configuration, each respective subsidiary work surface frame is brought parallel with its primary work surface frame and additionally comprising first and/or second subsidiary work surfaces provided to the first and/or second subsidiary work surface frames.

39. A workbench according to claim 37, wherein the central spine defines a rectangular top surface that in the in-use configuration defines a central work surface of the workbench.

40. A workbench according to claim 39, wherein the width of said rectangular top surface corresponds essentially to the combined width of the first and second primary work surface frames and their respective first and second work surfaces, when brought together in the folded configuration.

41. A workbench according to claim 37, wherein in the folded configuration the first and second primary work surfaces rest flush with each other.

42. A workbench according to claim 37, wherein in the folded configuration, the legs rest flush with the underside of the first and second primary work surfaces.

43. A workbench according to claim 38, wherein in the folded configuration, the legs rest flush with the underside of the first and second subsidiary work surfaces.

44. A workbench according to claim 38, wherein the first and/or second subsidiary work surfaces are provided with an access hole to enable the user to access an actuator arm of any safety catch provided to the underside thereof.

45. A workbench according to claim 38, wherein at least one of the first and/or second subsidiary work surfaces mounts to its subsidiary work surface frame by a slide track mounting.

46. A workbench according to claim 37, additionally including a clamp.

47. A workbench according to claim 46, wherein said clamp is provided to the first and/or second primary work surfaces and/or the first and/or second subsidiary work surfaces.

48. A workbench according to claim 46, wherein the clamp comprises a base defining a plug sized and shaped for receipt within an access hole of a subsidiary work surface of the workbench.

49. A workbench according to claim 48, wherein said base is provided with a flange, which in-use seats against the subsidiary work surface when the plug seats within the access hole.

50. A workbench according to claim 48, wherein said plug includes a lateral slot arranged for receipt of a securing bolt for securing an arrangement of a lower jaw;
compressible block; and upper jaw to the base.

51. A workbench according to claim 50, wherein said securing bolt is provided with a head, which is arranged to receive a handle.

52. A workbench according to claim 51, wherein turning movement of said handle causes a loosening of the securing bolt, which enables the jaw and block arrangement to be moved laterally within the slot.

53. A workbench according to claim 52, wherein a reverse turning movement of the handle relative to the base allows for securing of the jaw and block arrangement at a particular lateral position within the slot of the base.

54. A workbench according to claim 53, wherein said reverse turning movement of the handle compresses said compressible block, which expands outwardly to exert a clamping force.

55. A workbench according to claim 51, wherein the clamp is additionally provided with one or more stops to prevent overtravel of the handle.

56. A workbench according to claim 17, additionally comprising a tray provided to the tray framework.

57. A workbench according to claim 36 in kit of parts form.

58. Kit of parts comprising a:
workbench having a frame assembly that is reversibly foldable from an in-use to a foldable configuration, the frame assembly having:
a central spine,
first and second primary work surface frames, each work surface frame having an inner edge, an outer edge and two side edges, wherein each said inner edge thereof hingedly mounts to the central spine such that the primary work surface frames are foldable towards each other, and
first and second opposing pairs of legs, each leg pivotally mounting to one end of an outer edge of the first and second primary work surface frames, such that the legs of each opposing pair are foldable towards each other,
wherein the inner edge of each of the first and second primary work surface frames hingedly mounts to the central spine by a distinct hinge mounting such that in the folded configuration, opposing side edges of the respective first and second primary work surface frames are brought parallel with each other and each of the legs is brought parallel with a side edge thereof, further comprising
first and second primary work surfaces provided to the first and second primary work surface frames; and
a wall mounting suitable for mounting one half of the workbench in its folded configuration whilst the other half is in the in-use configuration.
